(19) United States
(12) Patent Application Publication
(10) Pub. No.: US 2019/0296327 A1
(43) Pub. Date: Sep. 26, 2019

(54) ELECTRODE, SECONDARY BATTERY, BATTERY PACK, AND VEHICLE

(71) Applicant: KABUSHIKI KAISHA TOSHIBA, Minato-ku (JP)

(72) Inventors: Kazuki ISE, Kawasaki (JP); Yasuhiro HARADA, Isehara (JP); Norio TAKAMI, Yokohama (JP)

(73) Assignee: KABUSHIKI KAISHA TOSHIBA, Minato-ku (JP)

(21) Appl. No.: 16/122,072

(22) Filed: Sep. 5, 2018

(30) Foreign Application Priority Data
Mar. 26, 2018 (JP) 2018-057473

(51) Int. Cl. H01M 4/133; H01M 4/36; H01M 4/485; H01M 10/0525; H01M 10/42; H01M 2/10; H01M 2/30; H01M 4/62

(52) U.S. Cl. CPC H01M 4/133; H01M 4/366; H01M 4/485; H01M 10/0525; H01M 2004/021; H01M 2/1016; H01M 2/30; H01M 4/621; H01M 10/425

(57) ABSTRACT

According to one embodiment, an electrode is provided. An average particle size L1 of the primary particles of the active material and an average particle size L2 of primary particles of the carbon particles satisfy the following formula (1).

L1/100≤L2≤L1/10 (1)

A covering ratio of the active material by the carbon particles is not less than 80%. The covering ratio is a ratio of a mapping area of the carbon particles to a mapping area of the active material on a mapping image of a section of the active material-containing layer by Raman spectroscopy.

### CROSS-REFERENCE TO RELATED APPLICATIONS

This application is based upon and claims the benefit of priority from Japanese Patent Application No. 2018-057473, filed Mar. 26, 2018, the entire contents of which are incorporated herein by reference.

### FIELD

Embodiments described herein relate generally to an electrode, a secondary battery, a battery pack, and a vehicle.

### BACKGROUND

In recent years, a secondary battery such as a lithium-ion secondary battery or a nonaqueous electrolyte secondary battery has been developed as a battery having a high energy density. The secondary battery is expected to be used as a power source for vehicles such as a hybrid automobile and an electric automobile, or as a large-sized power source for power storage. When the secondary battery is used as the power source for vehicles, the secondary battery is required to achieve rapid charge-and-discharge performance and long-term reliability or the like in addition to the high energy density.

Lithium ions and electrons rapidly move through an electrolyte and an external circuit respectively between a positive electrode and a negative electrode which can allow the lithium ions and the electrons to be inserted and extracted, to enable to perform rapid charge-and-discharge. The battery capable of performing rapid charge-and-discharge has the advantage that a charging time is considerably short. When the battery capable of performing rapid charge-and-discharge is used as the power source for vehicles, the motive performances of the automobile can be improved, and the regenerative energy of power can be efficiently recovered.

A carbon-based negative electrode using a carbonaceous material such as graphite as a negative electrode active material is used as a negative electrode which can allow the lithium ions and the electrons to be inserted and extracted. However, when rapid charge-and-discharge is repeated in a battery including the carbon-based negative electrode, dendrites of metal lithium may precipitate on the negative electrode. The dendrites of metal lithium may cause an internal short circuit. Therefore, when the rapid charge-and-discharge is repeated in the battery including the carbon-based negative electrode, a concern is raised that heat generation and ignition may occur.

Therefore, a battery including a negative electrode using a metal composite oxide as the negative electrode active material in place of the carbonaceous material has been developed. In particular, in a battery using a titanium oxide of the metal composite oxide as the negative electrode active material, the dendrites of metal lithium are less likely to precipitate even when rapid charge-and-discharge is repeated as compared with those of the battery including the carbon-based negative electrode. The battery using the titanium oxide has more stable rapid charge-and-discharge and a longer life than those of the battery including the carbon-based negative electrode.

However, the titanium oxide has a higher (nobler) potential relative to lithium metal than that of the carbonaceous material. In addition, the titanium oxide has a lower theoretical capacity per unit mass than that of the carbonaceous material. For this, there is a problem that the battery including a negative electrode using the titanium oxide as the negative electrode active material has a lower energy density than that of the battery including the carbon-based negative electrode.

In view of the above, a new electrode material containing titanium and niobium has been studied. In particular, in a monoclinic niobium-titanium composite oxide represented by Nb₂TiO₇, tetravalent titanium ions are reduced to trivalent titanium ions and pentavalent niobium ions are reduced to trivalent niobium ions when lithium ions are inserted. Therefore, this monoclinic niobium-titanium composite oxide can maintain the electric neutrality of a crystal structure even when many lithium ions are inserted, as compared with the titanium oxide. As a result, the monoclinic Nb—Ti composite oxide represented by Nb₂TiO₇ has a high theoretical capacity of 387 mAh/g.

### BRIEF DESCRIPTION OF THE DRAWINGS

FIG. 1 is a schematic view showing an example of the crystal structure of the monoclinic niobium-titanium composite oxide;

FIG. 2 is a schematic view of the crystal structure shown in FIG. 1 as viewed from another direction;

FIG. 3 is a graph showing an example of the XPS spectrum of the active material;

FIG. 4 is a cross-sectional view schematically showing an example of a secondary battery according to the second embodiment;

FIG. 5 is an enlarged cross-sectional view of section A of the secondary battery shown in FIG. 4;

FIG. 6 is a partially cut-out perspective view schematically showing another example of a secondary battery according to the second embodiment;

FIG. 7 is an enlarged cross-sectional view of section B of the secondary battery shown in FIG. 6;

FIG. 8 is a perspective view schematically showing an example of the battery module according to the third embodiment;

FIG. 9 is an exploded perspective view schematically showing an example of the battery pack according to the fourth embodiment;

FIG. 10 is a block diagram showing an example of an electric circuit of the battery pack shown in FIG. 9;

FIG. 11 is a cross-sectional view schematically showing an example of a vehicle according to the fifth embodiment; and

FIG. 12 is a view schematically showing another example of the vehicle according to the fifth embodiment.

### DETAILED DESCRIPTION

According to one embodiment, an electrode is provided. The electrode includes an active material-containing layer. The active material-containing layer includes an active material composite material. The active material composite material includes an active material and carbon particles. The active material includes primary particles. The carbon particles include primary particles. An average particle size L1 of the primary particles of the active material and an average particle size L2 of primary particles of the carbon particles satisfy the following formula (1).

L1/100≤L2≤L1/10 (1)

A covering ratio of the active material by the carbon particles is not less than 80%. The covering ratio is a ratio of a mapping area of the carbon particles to a mapping area of the active material on a mapping image of a section of the active material-containing layer by Raman spectroscopy.

According to another embodiment, a secondary battery is provided. The secondary battery includes a negative electrode, a positive electrode, and an electrolyte. The negative electrode is the electrode according to the embodiment.

According to another embodiment, a battery pack is provided. The battery pack includes the secondary battery according to the embodiment.

According to another embodiment, a vehicle is provided. The vehicle includes the battery pack according to the embodiment.

### First Embodiment

According to the first embodiment, an electrode is provided. The electrode includes an active material-containing layer. The active material-containing layer includes an active material composite material. The active material composite material includes an active material and carbon particles. The active material includes primary particles. The carbon particles include primary particles. An average particle size L1 of the primary particles of the active material and an average particle size L2 of primary particles of the carbon particles satisfy the following formula (1).

L1/100≤L2≤L1/10 (1)

A covering ratio of the active material by the carbon particles is not less than 80%. The covering ratio is a ratio of a mapping area of the carbon particles to a mapping area of the active material on a mapping image of a section of the active material-containing layer by Raman spectroscopy.

In the active material composite particles contained in the electrode according to the first embodiment, a ratio L2/L1 of an average particle size L2 of the primary particles of the carbon particles to an average particle size L1 of the primary particles of the active material ranges from 0.01 to 0.1. That is, in the active material particles contained in the electrode according to the first embodiment, the primary particles of the active material carry fine carbon particles each having a size from 1/100 to 1/10 of the size of the primary particles of the active material.

On a mapping image of a section of the active material-containing layer by Raman spectroscopy, the area ratio of the mapping portion of the carbon particles existing on a portion where the active material is mapped, that is, the coverage (the covering ratio) is 80% or more. That is, in the active material-containing layer, the carbon particles also exist in most of the portion where the active material exists.

It can be said, from the above-described fact, that in the electrode according to the first embodiment, the carbon particles much smaller than the primary particles of the active material are distributed in most of the portion where the active material exists. Hence, in the electrode according to the first embodiment, it is considered that the fine carbon particles are carried by the primary particles of the active material in a state in which the carbon particles are satisfactorily dispersed. When such an electrode is used, the rapid charge-and-discharge performance and the cycle performance of the secondary battery can be improved. The reason for this will be described below.

First, when a monoclinic niobium-titanium composite oxide or the like is used as a negative electrode active material, the electron conductivity of the active material tends to lower in a low state of charge (SOC), that is, in a state in which lithium ions are not sufficiently inserted into the negative electrode active material. To raise the electron conductivity of the active material, a conductive agent made of carbon particles is arranged among the primary particles in some cases. The carbon particles arranged among the primary particles are connected to each other in a mesh pattern, thereby forming a network of the conductive agent, that is, a conductive path. By the formation of the conductive path, the electron conductivity among the primary particles of the active material is improved.

However, when the secondary battery is charged, the lithium ions are inserted into the negative electrode active material, and therefore, the shape of the primary particles can be expanded. In addition, when the secondary battery is discharged, the lithium ions are extracted from the negative electrode active material, and therefore, the shape of the primary particles can be contracted. When the primary particles of the active material repeat the shape change in this way, the conductive path among the primary particles can be destroyed, and the electron conductivity may lower. In particular, such a change in the shape of the primary particles of the active material can remarkably occur during rapid charge-and-discharge. Hence, when rapid charge-and-discharge is repetitively performed for the secondary battery, the conductive path among the primary particles is destroyed, and therefore, the cycle characteristic lowers.

In the electrode according to the first embodiment, the fine carbon particles exist in a state in which they are satisfactorily dispersed among the primary particles of the active material. Hence, even if rapid charge-and-discharge is repeated, the conductive path is hardly destroyed, and a satisfactory electron conductivity can be maintained. For this reason, when the electrode according to the first embodiment is used, the rapid charge-and-discharge performance and the cycle performance of the secondary battery can be improved.

The electrode according to the first embodiment will be described below in detail.

The electrode according to the first embodiment can be an electrode for a battery. The electrode according to the first embodiment is used as, for example, a negative electrode.

The electrode according to the first embodiment can include a current collector and an active material-containing layer.

1) Current Collector

The current collector is a material which is electrochemically stable at the insertion and extraction potentials of lithium ions of the active material. For example, if the active material is used as the negative electrode active material, the current collector is preferably made of copper, nickel, stainless, aluminum, or an aluminum alloy containing one or more elements selected from Mg, Ti, Zn, Mn, Fe, Cu, and Si. The thickness of the current collector is preferably 5 μm to 20 μm. The current collector having such a thickness can achieve a balance between the strength and reduction in weight of the electrode.

The current collector can include a portion on one side where the negative electrode active material-containing layer is not carried on any surfaces. This portion acts as a negative electrode current collector tab.

2) Active Material-Containing Layer

The active material-containing layer can be formed on one surface or both surfaces of the current collector. The active material-containing layer contains an active material composite material serving as an active material, and arbitrarily contains a conductive agent and a binder.

The content of the active material, the conductive agent, and the binder in the active material-containing layer may be appropriately changed depending on its application of the electrode. For example, if the electrode is used as the negative electrode of the secondary battery, it is preferable that the active material, the conductive agent, and the binder are respectively blended at rates of 68% by mass to 96% by mass, 2% by mass to 30% by mass, and 2% by mass to 30% by mass. The content of the conductive agent of 2% by mass or more makes it possible to improve the current collection performance of the active material-containing layer. The amount of the binder of 2% by mass or more provides sufficient binding property between the active material-containing layer and the current collector, which can provide promising excellent cycle performance. On the other hand, the contents of the conductive agent and binder are preferably 30% by mass or less, thereby increasing the capacity.

The density of the active material-containing layer preferably ranges from 1.8 g/cm³ to 2.8 g/cm³. An electrode in which the density of the active material-containing layer falls within this range is excellent in the energy density and the retention property of an electrolyte. The density of the active material-containing layer more preferably ranges from 2.1 g/cm³ to 2.6 g/cm³.

2-1) Active Material Composite Material

The active material composite material contains an active material and carbon particles that cover at least part of the surface of the active material. The active material composite material may contain a dispersant. The active material composite material can have the form of particles.

On a mapping image of a section of the active material-containing layer by Raman spectroscopy, the ratio of the mapping area of the carbon particles to the mapping area of the active material, that is, the coverage (the covering ratio) is 80% or more. The high coverage can indicate that the dispersibility of the carbon particles carried by the primary particles of the active material is high in the active material composite material. The coverage is preferably 90% or more and, more preferably, 95% or more. The ratio does not particularly have an upper limit, but is, for example, 100% or less.

The coverage can be obtained by mapping measurement using microscopic Raman spectroscopic analysis. This method will be described below in detail.

First, an electrode is extracted from the battery to obtain a measurement sample. At this time, a state close to a state in which the lithium ions are completely extracted from the active material in the electrode is obtained. For example, if the active material is contained in the negative electrode, the battery is set in a completely discharged state. For example, the battery is discharged in a 25° C. environment using a 0.1 C current up to the rated end voltage or until the battery voltage reaches 1.0 V. This process is repeated a plurality of times such that the current value at the time of discharge becomes not more than 1/100 of the rated capacity, thereby setting the battery in the discharged state.

Next, the battery is disassembled in a dry atmosphere such as a glove box filled with argon to extract the electrode. The extracted electrode is cleaned by an appropriate solvent and subjected to vacuum drying. As the solvent, for example, ethyl methyl carbonate or the like is used. For the electrode after the vacuum drying, it is confirmed that a white deposit such as lithium salt does not exist on the surface of the electrode. An electrode sample is thus obtained.

Next, the electrode sample is cut in a direction parallel to the thickness direction to expose a section. When cutting, for example, milling such as argon ion milling is performed, and the exposed surface is analyzed using a confocal micro-Raman spectrometer, thereby obtaining a mapping image.

More specifically, first, the measurement sample is set in the micro-Raman spectrometer such that the section of the measurement sample can be observed. Next, area analysis is performed for the whole observation field, and the Raman spectrum of each point is measured.

In the measurement, the measurement range is set to, for example, a square whose sides are 300 μm long each, the resolution is 1 μm, the measurement wavelength is 532 nm, the laser irradiation time is 10 sec or more, and the irradiation count is 3 or more. As the confocal micro-Raman spectrometer, for example, a confocal Raman spectroscopic apparatus available from HORIBA is used.

Next, a Raman mapping image concerning a peak belonging to the active material is obtained based on the thus obtained Raman spectra. If the active material is a monoclinic niobium-titanium composite oxide, the peak belonging to the active material appears within the range in which the Raman shift is 970 cm⁻¹ to 1,010 cm⁻¹.

Next, the mapping image concerning the active material is divided into regions each having 50-μm long sides. Then, in each divided region, A ratio S1 (A2/A1×100) of an area A2 of a portion where the active material is mapped to an entire divided region A1 is calculated. Next, 10 divided regions in which the ratio S1 is 70% or more are extracted.

Next, for the extracted regions, a Raman mapping image concerning a peak belonging to the carbon particles is obtained based on the thus obtained Raman spectra. The peak belonging to the carbon particles appears within the range in which the Raman shift is 1,530 cm⁻¹ to 1,630 cm⁻¹.

Next, the Raman mapping image concerning the active material and the Raman mapping image concerning the carbon particles are superimposed, and an area A3 of a portion where the carbon particles existing on the portion where the active material is mapped are mapped is calculated. Next, a ratio S2 (A3/A1×100) of the area A3 of the portion where the carbon particles existing on the portion where the active material is mapped are mapped to the entire divided region A1 is calculated.

Next, the ratio (S2/S1×100) of the ratio S2 to the ratio Si is calculated. The ratio (S2/S1×100) can be translated to the ratio (A3/A2×100) of the area A3 of the portion where the carbon particles are mapped to the area A2 of the portion where the active material is mapped. The calculation of the ratio (S2/S1×100) of the ratio S2 to the ratio S1 is done in each of the 10 extracted regions, and the average value of the ratios is obtained as the ratio of the mapping area of the carbon particles to the mapping area of the active material, that is, the coverage (the covering ratio).

2-1-1) Active Material

The active material is in a form of, for example, particles. The active material can have single primary particles, secondary particles each formed from an aggregate of plurality of primary particles, or a mixture thereof.

The average particle size L1 of the primary particles of the active material preferably ranges from 0.1 μm to 5 μm. When the average particle size L1 of the primary particles of the active material falls within this range, the diffusion property of lithium ions and the electrolyte impregnation property can compatibly be implemented. The average particle size L1 of the primary particles of the active material more preferably ranges from 0.5 μm to 3.0 μm.

The average particle size L1 of the primary particles of the active material can be obtained by TEM (Transmission Electron Microscope) observation.

More specifically, first, an electrode sample is obtained by the same method as described above. Next, the electrode sample is captured using the TEM at a magnification of, for example, 500,000× to 20,000×, which clearly shows the primary particles. A primary particle whose whole body is seen is selected from the primary particles included on the TEM image. Next, the primary particle is approximated to an ellipse. In this approximation, the ratio of the long axis to the short axis of the ellipse is set such that the difference between the outline of the primary particle and the outline of the circumference of the ellipse is minimized. Next, the lengths of the long axis and the short axis of the ellipse are measured. The arithmetic mean value of the lengths of the long axis and the short axis of the thus obtained ellipse is defined as the particle size of the primary particle. The same operation as described above is performed for 100 particles selected at random, and an arithmetic mean value of the 100 particles is defined as the average particle size L1 of the primary particles.

The average secondary particle size of the active material preferably ranges from 1 μm to 50 μm. When the average secondary particle size of the active material is set within this range, productivity at the time of battery manufacture can be improved, and a battery of excellent performance can be obtained. The average secondary particle size of the active material is measured by the following method. Using a laser diffraction distribution measuring apparatus (SALD-300 available from Shimadzu or a device with a function equivalent to this), first, an about 0.1 g of a sample, a surfactant, and 1 to 2 mL of distilled water are put in a beaker, sufficiently stirred, and poured into a stirring tank. A luminous intensity distribution is measured 64 times at an interval of 2 sec, and particle size distribution data is analyzed.

The BET specific surface area of the active material according to the first embodiment is preferably 3.0 m²/g to 120 m²/g, and more preferably 4.0 m²/g to 110 m²/g. When an active material with a large specific surface area is used, the discharge rate characteristic of the battery can be improved. In addition, when an active material with a small specific surface area is used, the life characteristic of the battery can be improved, and in an electrode manufacturing step to be described later, the coating properties of a slurry containing the active material can be improved.

The BET specific surface area means a specific surface area obtained by a nitrogen BET (Brunauer, Emmet and Teller) method. The specific surface area based on the nitrogen BET method can be obtained by the following method.

First, 4 g of the active material are collected as a sample. Next, the evaluation cell of a measuring apparatus is vacuum-dried at a temperature of 100° C. or more for 15 hrs to perform degassing. As the evaluation cell, for example, a ½-inch cell can be used. Next, the sample is placed in the measuring apparatus. As the measuring apparatus, for example, TriStar II 3020 available from Shimadzu-Micromeritics Instrument can be used. Then, in a nitrogen gas at 77K (the boiling point of nitrogen), while gradually increasing a pressure P (mmHg) of the nitrogen gas, the nitrogen gas adsorption amount (mL/g) of the sample is measured for each pressure P. Next, a value obtained by dividing the pressure P (mmHg) by a saturated vapor pressure P₀ (mmHg) of the nitrogen gas is defined as a relative pressure P/P₀, and a nitrogen gas adsorption amount corresponding to each relative pressure P/P₀ is plotted, thereby obtaining an adsorption isotherm. A BET plot is calculated from the nitrogen adsorption isotherm and the BET equation, and the specific surface area is obtained using the BET plot. Note that a BET multipoint method is used to calculate the BET plot.

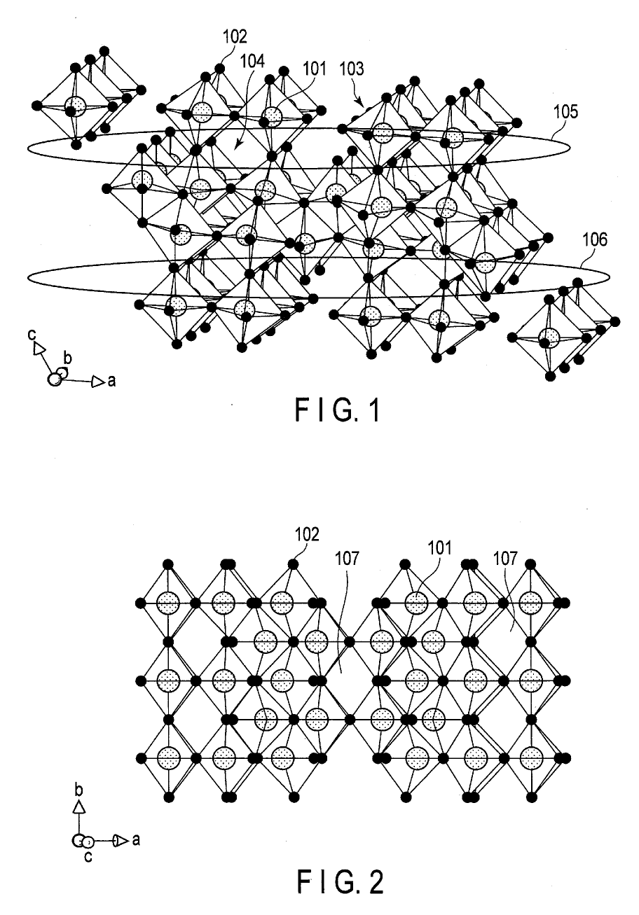

The active material is preferably a monoclinic niobium-titanium composite oxide. The crystal structure of the monoclinic niobium-titanium composite oxide belongs to a space group C2/m. FIG. 1 is a schematic view showing an example of the crystal structure of the monoclinic niobium-titanium composite oxide. FIG. 2 is a schematic view of the crystal structure shown in FIG. 1 as viewed from another direction. FIGS. 1 and 2 shows the crystal structure of Nb₂TiO₇ as an example of a monoclinic niobium-titanium composite oxide. Referring to FIGS. 1 and 2, an a-axis direction is a direction orthogonal to a b-axis direction, and a c-axis direction is a direction orthogonal to the b-axis direction.

As shown in FIGS. 1 and 2, the crystal structure of Nb₂TiO₇ has a configuration in which metal ions 101 and oxide ions 102 constitute a skeleton structure portion 103. In each metal ions 101, niobium (Nb) ions and titanium (Ti) ions are arranged in the ratio of Nb to Ti of 2:1 at random. The skeleton structure portions 103 are alternately arranged three-dimensionally. The vacancies 104 are provided among the skeleton structure portions 103. The vacancies 104 are hosts for lithium ions. The vacancies 104 occupy a large portion with respect to the entire crystal structure as show in FIG. 1. In addition, the vacancies 104 can maintain a structure stably even if lithium ions are inserted.

Each of regions 105 and 106 shown in FIG. 1 has a two-dimensional channel in the [100] direction, that is, the a-axis direction and the [010] direction, that is, the b-axis direction. As shown in FIG. 2, the crystal structure of Nb₂TiO₇ has vacancies 107. The vacancy 107 has a tunnel structure which is suitable for conduction of lithium ions. The vacancy 107 is connected to the region 105 and the region 106 as a conductive path. The presence of the conductive path allows the lithium ions to come and go between the region 105 and the region 106.

The crystal structure of the monoclinic niobium-titanium composite oxide shown in FIGS. 1 and 2 has a large space into which the lithium ions are equivalently inserted, and has a structural stability. Additionally, in the crystal structure, a plurality of conductive paths to quickly diffuse lithium ions exist. Therefore, in the crystal structure of the monoclinic niobium-titanium composite oxide, the insertion properties of the lithium ions to the insertion space and the extraction properties of the lithium ions from the insertion space are improved, and the insertion-and-extraction space for the lithium ions is effectively increased. Accordingly, a high capacity and high rate performance can be implemented.

Furthermore, in the above-mentioned crystal structure, when a lithium ion is inserted into the vacancy 104, the metal ion 101 constituting the skeleton structure portion 103 is reduced to trivalent, thereby maintaining the electrical neutrality of the crystal. In the monoclinic niobium-titanium composite oxide, not only the Ti ion is reduced from tetravalent to trivalent, but also the Nb ion is reduced from pentavalent to trivalent. For this, the number of reduced valences per active material weight is large. Therefore, even when a large number of lithium ions are inserted, the electrical neutrality of the crystal can be maintained. For this, the monoclinic niobium-titanium composite oxide has a higher energy density than that of a compound such as a titanium oxide containing only a tetravalent cation. Specifically, the theoretical capacity of the monoclinic niobium-titanium composite oxide is about 387 mAh/g, which is more than twice the value of a titanium oxide having a spinel structure.

The monoclinic niobium-titanium composite oxide is represented by, for example, a general formula LiaTi₁₋ₓM1ₓNb_{2-y}M2_{y}O₇. Note that in the above general formula, 0≤a<5, 0≤x<1, and 0≤y<1. The elements M1 and M2 are respectively at least one selected from the group consisting of V, Ta, Fe, Bi, Sb, As, P, Cr, Mo, W, B, Na, Mg, Al, and Si. The elements M1 and M2 may be the same element or may be elements different from each other.

As the element M1, it is preferable to use at least one element of Fe and A1. These elements are trivalent elements. Therefore, the use of these elements as the element M1 makes it possible to improve the electron conductivity of the monoclinic niobium-titanium composite oxide. Therefore, the use of these elements as the element M1 makes it possible to improve the capacity and rapid charge performance of the battery.

From the viewpoint of improving electron conductivity, it is more preferable to use at least one element selected from the group consisting of V, Ta, Bi, Sb, As, and P as the element M1. Since these elements are pentavalent elements, the electron conductivity of the monoclinic niobium-titanium composite oxide can be further improved.

As the element M1, it is preferable to use at least one element selected from the group consisting of B, Na, Mg, and Si. The atomic weights of these elements are smaller than the atomic weight of Ti. Therefore, the use of these elements as the element M1 makes it possible to increase the capacity of the battery electrode.

As the element M2, it is preferable to use at least one element selected from the group consisting of Cr, Mo, and W. Since these elements are hexavalent elements, the electron conductivity of the monoclinic niobium-titanium composite oxide can be improved.

The use of Ta as the element M2 makes it possible to obtain a monoclinic niobium-titanium composite oxide having the same performance as that in the case of using Nb as the element M2. This is considered to be because Nb and Ta have the same physical, chemical, and electrical properties.

As the elements M1 and M2, at least one element selected from the group consisting of Mo, W, and V may be used. These elements exhibit an effect as a sintering auxiliary agent. Therefore, the use of these elements as at least one of M1 and M2 makes it possible to lower a firing temperature in producing the monoclinic niobium-titanium composite oxide.

The active material can also be represented by the general formula LiₐTi₁₋ₓMₓNb₂O₇ (0≤a<5, 0≤x<1). M in the general formula is the same as M1 described above.

The content of the elements M1 and M2 in the compound represented by the general formula LiₐTi₁₋ₓM1ₓNb_{2-y}M2_{y}O₇ and the content of the element M in the compound represented by the general formula LiₐTi₁₋ₓMₓNb₂O₇ can be quantified, for example, by ICP spectroscopic analysis.

The active material may contain an oxide having a composition which is beyond a stoichiometric ratio represented by the general formula LiₐTi₁₋ₓM1ₓNb₂M2_{y}O₇ (0≤a<5, 0≤x<1, 0≤y<1). The oxide can be represented by the general formula LiₐTi₁₋ₓM1ₓNb_{2-y}M2_{y}O_{7+δ} (0≤a<5, 0≤x<1, 0≤y<1, −0.3≤δ≤0.3).

That is, during the preparation of the monoclinic niobium-titanium composite oxide, oxygen defects may occur in a raw material or an intermediate product. Inevitable impurities contained in the raw material as well as impurities mixed therein during the preparation may be present in the composite oxide. Due to the unavoidable factor, a monoclinic niobium-titanium composite oxide containing an oxide having a composition beyond a stoichiometric ratio may be prepared in some cases. The oxide having a composition beyond a stoichiometric ratio has excellent lithium ion insertion stability as with an oxide having a composition having a stoichiometric ratio. Therefore, even when the monoclinic niobium-titanium composite oxide contains the oxide having a composition beyond a stoichiometric ratio, the influence on the lithium ion insertion capacity is small.

The monoclinic niobium-titanium composite oxide may contain different phases with different Nb/Ti ratios. Examples of the different phases include Rutile type TiO₂, Nb₂₄TiO₆₂, Nb₁₄TiO₃₇, and Nb₁₀Ti₂O₂₉.

As the monoclinic niobium-titanium composite oxide, only one kind of monoclinic niobium-titanium composite oxide particles may be used, and mixtures of a plurality of kinds of monoclinic niobium-titanium composite oxides may be used.

The active material may be an active material other than the monoclinic niobium-titanium composite oxide. Examples of the other active material include a lithium titanate having a ramsdellite structure. (for example, Li_{2+y}Ti₃O₇ (0≤y≤3), a lithium titanate having a spinel structure (for example, Li₄₊ₓTi₅O₁₂ (0≤x≤3)), monoclinic titanium dioxide (TiO₂), anatase type titanium dioxide, rutile type titanium dioxide, a hollandite type titanium composite oxide, and an orthorhombic titanium composite oxide.

Examples of the orthorhombic titanium composite oxide includes a compound represented by a general formula of Li₂₊ₐM(I)_{2-b}Ti_{6-c}M(II)_{d}O_{14+σ}. M(I) is at least one element selected from the group consisting of Sr, Ba, Ca, Mg, Na, Cs, Rb, and K. M(II) is at least one element selected from the group consisting of Zr, Sn, V, Nb, Ta, Mo, W, Y, Fe, Co, Cr, Mn, Ni, and A1. In the general formula, 0≤a≤6, 0≤b<2, 0≤c<6, 0≤d<6, −0.5≤δ≤0.5. Specific examples of the orthorhombic titanium composite oxide include Li₂₊ₐNa₂Ti₆O₁₄ (0≤a≤6).

A method of confirming the crystal structure and the composition of the active material will be described next.

Powder XRD (X-Ray Diffraction) measurement will be described first. By the powder XRD, the crystal structure of the active material can be confirmed.

In the powder XRD measurement, first, the electrode sample after cleaning, which is obtained by the above-described method, is cut into almost the same area as the area of the holder of the powder XRD apparatus to obtain a measurement sample. Next, the measurement sample is directly bonded to a glass holder and set in the powder XRD apparatus, and an XRD pattern (X-Ray Diffraction pattern) is acquired using Cu-Kα rays. This diffraction pattern is analyzed by a Rietveld method, thereby confirming the crystal structure of the active material.

Note that peaks derived from components other than the active material that can be contained in the electrode are preferably grasped in advance. The components other than the active material are, for example, a metal foil as the current collector, the conductive agent, and the binder. Note that if the peak of the current collector and the peak of the active material overlap, the active material-containing layer is preferably peeled from the current collector and subjected to measurement. This is because when quantitatively measuring the peak intensity, the overlapping peaks are separated. The active material-containing layer can be peeled by, for example, irradiating the electrode current collector with an ultrasonic wave in a solvent.

As the apparatus of powder XRD measurement, for example, SmartLab available from Rigaku is used. The measurement conditions are as follows.

X-ray source: Cu target

Output: 45 kV, 200 mA

Solar slit: 5° for both incidence and light reception

Step width (2θ): 0.02 deg

Scan speed: 20 deg/min

Semiconductor detector: D/teX Ultra 250

Sample holder: flat glass sample plate holder (thickness: 0.5 mm)

Measurement range: 5°≤2θ≤90°

When another apparatus is used, measurement is performed using a standard Si powder for powder XRD, and measurement is performed after the conditions are adjusted to conditions under which the peak intensity and the peak top position match those of the above apparatus such that the same measurement result as described above can be obtained.

The conditions of the powder XRD measurement are set to conditions that enable to acquire an XRD pattern applicable to Rietveld analysis. To collect data for Rietveld analysis, more specifically, the step width is set to ⅓ to ⅕ of the minimum half-value width of the diffraction peak, and the measurement time or the X-ray intensity is appropriately adjusted such that the intensity at the peak position of the strongest intensity reflection becomes 5,000 cps.

Note that the powder of the active material is used as the measurement sample, powder XRD measurement is performed by the following method. More specifically, first, the powder of the active material is pulverized until the average particle size becomes about 10 μm. The average particle size can be obtained by, for example, a laser diffraction method.

Next, the pulverized sample is packed in a holder portion that is 0.2 mm deep and is formed on a glass sample plate. As the glass sample plate, for example, a glass sample plate available from Rigaku is used. At this time, take care to sufficiently pack the sample in the holder portion. Also take care not to form a crack, a void, or the like due to insufficient pack of the sample. Next, using another glass plate from the outside, the glass plate is sufficiently pressed against the sample to flatten it. At this time, take care not to cause unevenness with respect to the reference surface of the holder due to an inappropriate pack amount.

Note that if the orientation of the sample is high, the peak position may be shifted, or the peak intensity ratio may change depending on the manner the sample is packed. For example, an orientation may be recognized from the result of Rietveld analysis to be described later in which the crystal surfaces may be aligned in a specific direction depending on the shapes of the particles when packing the sample. Alternatively, the influence of the orientation may be observed when the measurement sample obtained by extraction from the battery is measured.

Such a sample with a high orientation is measured in a form of a pellet. The pellet is, for example, a green compact having a diameter of 10 mm and a thickness of 2 mm. The green compact can be produced by applying a pressure of about 250 MPa to the sample for 15 min. The obtained pellet is set in the powder XRD apparatus, and the surface is measured. When the measurement is performed by this method, it is possible to eliminate the difference in the measurement result by the operator and raise the reproducibility.

If the intensity ratio measured by this method and the intensity ratio measured using the above-described flat plate holder or glass holder are different, it is considered that the influence of the orientation exists, and the measurement result obtained using the pellet is employed.

The method of confirming the composition of the active material will be described next. The composition of the active material can be analyzed using, for example, ICP (Inductively Coupled Plasma) atomic emission spectroscopy.

More specifically, in the electrode sample after cleaning, which is obtained by the above-described method, the current collector and the active material-containing layer are separated. For example, the electrode is put in an ethyl methyl carbonate solution in a glass beaker and vibrated in an ultrasonic cleaning machine, thereby peeling the active material-containing layer from the electrode current collector.

Next, the thus obtained active material-containing layer is heated in the air for a short time (for example, at 500° C. for about 1 hr) to burn off unnecessary portions such as the binder and the conductive agent, thereby obtaining an active material sample. Next, the active material sample is dissolved in an acid, thereby obtaining a liquid sample. As the acid, hydrochloric acid, nitric acid, sulfuric acid, hydrogen fluoride, or the like can be used. Next, the liquid sample is subjected to ICP analysis, thereby confirming the composition of the active material.

When a monoclinic niobium-titanium composite oxide is used as the active material, the number of oxygen defects in the crystal structure is preferably small. If the number of oxygen defects is small, insertion/extraction of Li in the active material interface is even and smooth, and therefore, stable charge-and-discharge tends to be possible.

That the number of oxygen defects in the active material is a small can be confirmed by XPS (X-ray Photoelectron Spectroscopy). That is, in the process of manufacturing the active material composite material to be described later, the monoclinic niobium-titanium composite oxide is sometimes fired under a reduction atmosphere. When such firing is performed, oxygen defects can be generated in the crystal structure on the surface of the monoclinic niobium-titanium composite oxide. Accordingly, on the surface of the monoclinic niobium-titanium composite oxide, quadrivalent titanium ions are reduced to trivalent or bivalent titanium ions. Hence, when an element concentration based on the peak of the trivalent or bivalent titanium ions in the sum of an element concentration based on the peak of the quadrivalent titanium ions and an element concentration based on the peak of the trivalent or bivalent titanium ions, which is obtained by XPS measurement, is confirmed, the amount of oxygen defects in the crystal structure of the monoclinic niobium-titanium composite oxide can be confirmed. That is, if the element concentration based on the peak of the trivalent or bivalent titanium ions is high by the XPS measurement, this can indicate that the number of oxygen defects in the crystal structure of the monoclinic niobium-titanium composite oxide is large.

Hence, the element concentration based on the peak belonging to at least either of the trivalent titanium ions and the bivalent titanium ions is preferably 1 atm % or less and, more preferably 0.1 atm % or less. The element concentration does not particularly have a lower limit, but is, for example, 0 atm % or more.

In the XPS, more specifically, an electrode sample is prepared first by the same method as described above. Next, the electrode sample is cut along the thickness direction by ion milling or the like, thereby obtaining a sample. Next, XPS measurement is performed for a surface of the active material-containing layer in the sample, thereby obtaining an XPS spectrum.

As the XPS apparatus, for example, Quantera® available from ULVAC-PHI is used. In the measurement, for example, excited X-rays are monochromatized Al Kα_{1,2}-rays, the X-ray irradiation diameter is 200 μm, and the photoelectron take-off angle is 45° C. In addition, PHI Multipak can be used as analysis software.

Then, wide scan analysis is performed for the obtained XPS spectrum, and elements contained in the measurement region are confirmed. Next, narrow scan analysis is performed for titanium observed by the wide scan analysis, thereby obtaining a narrow scan spectrum concerning titanium. Then, fitting is performed for the narrow scan spectrum of titanium, and the integrated intensity of the peak belonging to quadrivalent titanium ions and the integrated intensity of the peak belonging to at least either of the trivalent titanium ions and the bivalent titanium ions are calculated.

The peak belonging to the quadrivalent titanium ions appears within the range in which the binding energy of photoelectrons is 457 eV to 460 eV. The peak belonging to at least either of the trivalent titanium ions and the bivalent titanium ions appears within the range in which the binding energy of photoelectrons is 456 eV to 458 eV. Note that the peak belonging to the quadrivalent titanium ions appears on a high binding energy side with respect to the peak belonging to at least either of the trivalent titanium ions and the bivalent titanium ions.

The integrated intensity of the peaks is multiplied by a relative sensitivity coefficient corresponding to titanium, thereby calculating an atomic concentration based on the peak belonging to the quadrivalent titanium ions and an atomic concentration corresponding to the peak of the trivalent or bivalent titanium ions.

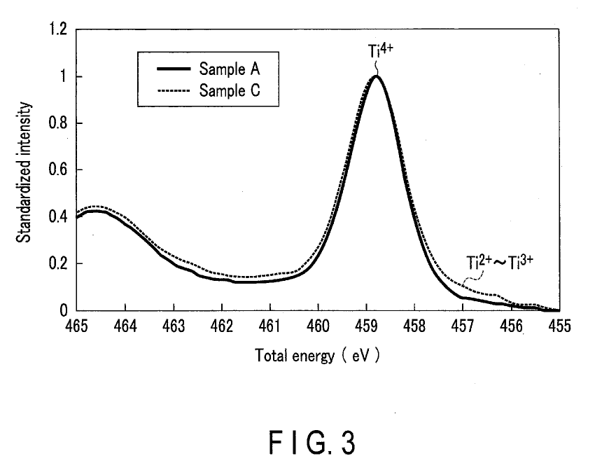

FIG. 3 is a graph showing an example of the XPS spectrum of the active material. In the graph shown in FIG. 3, the abscissa represents the binding energy, and the ordinate represents standardized intensity. In the graph shown in FIG. 3, the solid line indicates the XPS spectrum of a sample A, and the broken line indicates the XPS spectrum of a sample C. In the XPS spectra of the samples A and C shown in FIG. 3, a peak belonging to the trivalent or bivalent titanium ions is observed near 457 eV. In addition a peak belonging to the quadrivalent titanium ions is observed near 458.8 eV. An atomic concentration calculated from the peak belonging to the trivalent or bivalent titanium ions of the sample A is 0.1 atm %. An atomic concentration calculated from the peak belonging to the trivalent or bivalent titanium ions of the sample C is 5 atm %.

2-1-2) Carbon Particles

The carbon particles cover at least part of the surface of the active material. The carbon particles preferably cover the primary particles of the active material and, more preferably, evenly cover the whole surfaces of the primary particles of the active material.

The electron conductivity of the carbon particles is higher than the electron conductivity of the active material. The carbon particles carried by the primary particles of the active material can form the conductive path among the primary particles by coming into contact with each other.

The average particle size L2 of the primary particles of the carbon particles preferably ranges from 0.01 μm to 0.1 μm. When the average particle size L2 of the primary particles of the carbon particles falls within this range, the conductive network among the active material particles at the time of repeat of Li insertion/extraction of the active material is maintained, and the battery tends to be able to operate with stable life performance. The average particle size L2 of the primary particles of the carbon particles more preferably ranges from 0.3 μm to 0.6 μm and, more preferably, ranges from 0.4 μm to 0.5 μm.

The ratio L2/L1 of the average particle size L2 of the primary particles of the carbon particles to the average particle size L1 of the primary particles of the active material ranges from 0.01 to 0.1. If the ratio L2/L1 is higher than 0.1, the conductive network among the primary particles of the active material at the time of repeat of Li insertion/extraction of the active material is not maintained, and therefore, the cycle characteristic tends to lower. If the ratio L2/L1 is lower than 0.01, the electron conductive path along with volume expansion at the time of Li insertion cannot be maintained, and therefore, the cycle characteristic tends to lower. The ratio L2/L1 preferably ranges from 0.05 to 0.1.

The average particle size L2 of the primary particles of the carbon particles can be obtained by TEM (Transmission Electron Microscope) observation.

More specifically, first, an electrode sample is obtained by the same method as described above. Next, the electrode sample is captured using the TEM at a magnification of, for example, 50,000× to 3,000,000×, which clearly shows the primary particles. A primary particle whose whole body is seen is selected from the primary particles of the carbon particles included on the TEM image. Next, the primary particle is approximated to an ellipse. In this approximation, the ratio of the long axis to the short axis of the ellipse is set such that the difference between the outline of the primary particle and the outline of the circumference of the ellipse is minimized. Next, the lengths of the long axis and the short axis of the ellipse are measured. The arithmetic mean value of the lengths of the long axis and the short axis of the thus obtained ellipse is defined as the particle size of the primary particle. The same operation as described above is performed for 100 particles selected at random, and the arithmetic mean value of the 100 particles is defined as the average particle size L2 of the primary particles of the carbon particles.

The amount of carbon particles in the active material composite material preferably ranges from 0.1 mass % to 5 mass % and, more preferably, ranges from 0.2 mass % to 3 mass %.

The amount of carbon particles in the active material composite material can be measured by an inorganic element analysis method. That is, first, an active material sample prepared as a measurement target is put in an alumina crucible together with a combustion improver and burnt in an oxygen airflow by high frequency induction heating. At this time, since carbon is emitted as carbon dioxide. Hence, by detecting the carbon dioxide by an infrared detector, the carbon amount can be determined. As the measurement apparatus, for example, CS844 available from LECO can be used.

2-1-3) Dispersant

The dispersant improves the dispersibility of the carbon particles in the active material composite material. In addition, the dispersant binds the particles of the active material and the carbon particles. The dispersant is, for example, a polymer having hydrophilic side chains. When the degree of polymerization of the polymer or the ratio of hydrophilic side chains included in the polymer is adjusted, the carbon particles can be evenly carried by the surfaces of the particles of the active material. When the degree of polymerization of the polymer is low, the dispersibility of the carbon particles tends to rise. In addition, when the ratio of hydrophilic side chains included in the polymer is high, the dispersibility of the carbon particles tends to rise.

As the dispersant, for example, polyvinyl alcohol (PVA), an alginate, carboxymethyl cellulose (CMC), polyvinylidene fluoride (PVdF), or a mixture thereof is used.

As the dispersant, PVA, alginate, or a mixture thereof is preferably used. As the PVA, PVA whose degree of saponification is 90% to 99% is preferably used. When PVA whose degree of saponification falls within this range is used, the dispersibility of the carbon particles can further be improved. In addition, the weight-average molecular weight of PVA preferably ranges from 100 to 500. When PVA whose molecular weight falls within this range is used, the dispersibility of the carbon particles can further be improved.

As the alginate, sodium alginate, potassium alginate, ammonium alginate, or the like is preferable from the viewpoint of solubility in water.

The amount of the dispersant in the active material composite material preferably ranges from 0.1 mass % to 5 mass % and, more preferably, ranges from 0.5 mass % to 3 mass %. The amount of the dispersant in the active material composite material is calculated by, for example, thermogravimetric (TG) analysis.

2-2) Conductive Agent

The conductive agent may be blended to improve current collection performance and to suppress the contact resistance between the negative electrode active material and the current collector. Examples of the conductive agent include vapor grown carbon fiber (VGCF), carbon black such as acetylene black, and carbonaceous materials such as graphite. One of these may be used as the conductive agent, or two or more thereof may be used in combination as the conductive agent. Alternatively, in place of using the conductive agent, a carbon coating or an electron conductive inorganic material coating may be applied to the surfaces of the negative electrode active material particles.

2-3) Binder

The binder may be blended to fill the gaps of the dispersed active material with the binder and also to bind the active material and the negative electrode current collector. Examples of the binder include polytetrafluoro ethylene (PTFE), polyvinylidene fluoride (PVdF), fluorine-containing rubber, styrene-butadiene rubber, a polyacrylic acid compound, an imide compound, carboxymethyl cellulose (CMC) and salts of the CMC. One of these may be used as the binder, or two or more thereof may be used in combination as the binder.

3) Manufacturing Method

An example of a method of manufacturing the electrode according to the first embodiment will be described next. First, a synthesis method of the active material will be described. A description will be made here by exemplifying a monoclinic niobium-titanium composite oxide as the active material.

First, a titanium raw material and a niobium raw material are prepared. As the titanium raw material and the niobium raw material, oxides or salt powders containing titanium and niobium can be used. A detailed example of the titanium raw material is powder of titanium dioxide (TiO₂). A detailed example of the niobium raw material is powder of niobium pentoxide (Nb₂O₅). Next, the titanium raw material and the niobium raw material are mixed to obtain a powder mixture.

Next, the powder mixture and ethanol are mixed to obtain a solution mixture. Next, for the solution mixture, pulverization is performed using a wet ball mill. Then, the solution mixture after pulverization is filtered, and the filtered powder is dried to obtain a primary pulverized sample. Next, the primary pulverized sample is put into an alumina crucible and subjected to temporary firing.

In the temporary firing, the firing temperature is preferably set to 600° C. to 800° C. In addition, the firing time is preferably set to 1 hr to 10 hrs.

Next, the primary pulverized sample after temporary firing and ethanol are mixed to obtain a solution mixture. Next, for the solution mixture, pulverization is performed using a wet ball mill. Then, the solution mixture after pulverization is filtered, and the filtered powder is dried to obtain a secondary pulverized sample. Next, the secondary pulverized sample is put into an alumina crucible and subjected to final firing.

In the final firing, the firing temperature is preferably set to 900° C. to 1,500° C. If the temperature of final firing is low, the average particle size of the primary particles of the active material tends to be small. In addition, the firing time is preferably set to 1 hr to 20 hrs.

Next, the secondary pulverized sample after the final firing is further pulverized, thereby obtaining the powder of the active material.

A method of manufacturing the active material composite material will be described next.

First, carbon particles, a solvent, and arbitrarily, a dispersant are mixed and sufficiently stirred to prepare a dispersion. As the carbon particles, carbon black such as acetylene black, carbon nanofiber, carbon nanotube, graphene, or a mixture thereof can be used.

As the solvent, water may be used, or a nonaqueous solvent may be used. The water can be pure water, ion exchange water, purified water, tap water, or a mixture thereof. As the nonaqueous solvent, for example, ethanol, acetone, N-methyl-2-pyrrolidone, or a mixture thereof is used.

As the solvent, water is preferably used. When water is used as the solvent, PVA is preferably used as the dispersant. Since PVA is difficult to dissolve in water and is evenly dispersed in water, the dispersibility of the carbon particles can be improved.

As the dispersant, a dispersant difficult to dissolve in a solvent contained in a slurry used to form an active material-containing layer to be described later is preferably used. That is, when water is used as the solvent of the slurry of the active material-containing layer, a dispersant with low solubility in water is preferably used. When a nonaqueous solvent is used, a dispersant with high hydrophilicity is preferably used. When a dispersant difficult to dissolve in the solvent of the slurry of the active material-containing layer is used, the binding performance of the dispersant hardly lowers in the active material-containing layer, and the dispersibility of the carbon particles on the surfaces of the primary particles of the active material can be improved.

Next, the dispersion and the active material particles obtained by the above-described method are mixed to prepare a solution mixture. Next, a solvent is gradually added while stirring the solution mixture, thereby preparing a processing liquid. The solid component concentration in the processing liquid is preferably set to 5 mass to 50 mass %. Additionally, in the processing liquid, the amount of carbon particles to 100 parts by mass of the active material is preferably set to 1 parts by mass to 5 parts by mass. Furthermore, the amount of the dispersant to 100 parts by mass of the active material is preferably set to 0.1 parts by mass to 3 parts by mass.

Next, the solution mixture is subjected to spray dry. This can quickly dry fine droplets of the solution mixture in a gas. It is therefore possible to obtain a secondary particle shaped powder sample in a state in which the carbon particles are not agglomerated on the surfaces of the primary particles of the active material and are relatively evenly carried. Next, the obtained powder sample is further dried at a temperature of 70° C. to 150° C. The particles of the active material composite material are thus obtained.

Note that the active material composite material may be fired under the air atmosphere. The firing time is set to, for example, 1 hr to 10 hrs. The firing temperature is preferably set to 50° C. to 300° C.

Note that according to this method, since a process of firing the secondary particle shaped active material under a reduction atmosphere is not included, oxygen defects are hardly generated on the surfaces of the active material particles.

A method of manufacturing the electrode will be described next.

First, the particles of the active material composite material, the conductive agent, and the binder are suspended in a solvent to prepare a slurry. As the solvent, water is preferably used. When water is used, the dispersibility of the carbon particles in the active material composite material can be maintained. The slurry is applied to one surface or both surfaces of the current collector. Next, the applied slurry is dried to obtain the laminated body of the active material-containing layer and the current collector. After that, pressing is performed for the laminated body. The electrode is thus produced.

Alternatively, the electrode may be produced by the following method. First, the active material composite material, the conductive agent, and the binder are mixed to obtain a mixture. Next, the mixture is formed into pellets. Then, the pellets are arranged on the current collector, thereby obtaining the electrode.

According to the first embodiment described above, the electrode is provided. The electrode includes an active material-containing layer. The active material-containing layer includes an active material composite material. The active material composite material includes an active material and carbon particles. The active material includes primary particles. The carbon particles include primary particles. An average particle size L1 of the primary particles of the active material and an average particle size L2 of primary particles of the carbon particles satisfy the following formula (1).

L1/100≤L2≤L1/10 (1)

A covering ratio of the active material by the carbon particles is not less than 80%. The covering ratio is a ratio of a mapping area of the carbon particles to a mapping area of the active material on a mapping image of a section of the active material-containing layer by Raman spectroscopy.

Hence, when the electrode according to the first embodiment is used, the rapid charge performance and the cycle performance of the secondary battery can be improved.

### Second Embodiment

According to a second embodiment, a secondary battery including a negative electrode, a positive electrode and an electrolyte is provided. The secondary battery includes the electrode according to the first embodiment as the negative electrode.

The secondary battery according to the second embodiment can further include a separator disposed between the positive electrode and the negative electrode. The positive electrode, the negative electrode, and the separator can constitute an electrode group. The electrolyte may be held in the electrode group.

The secondary battery according to the second embodiment can further include a container member housing the electrode group and the electrolyte.

Furthermore, the secondary battery according to the second embodiment can further include a positive electrode terminal electrically connected to the positive electrode and a negative electrode terminal electrically connected to the negative electrode.

The secondary battery according to the second embodiment may be a lithium secondary battery. The secondary battery includes nonaqueous electrolyte secondary battery containing a nonaqueous electrolyte.

Hereinafter, the negative electrode, the positive electrode, the electrolyte, the separator, the container member, the positive electrode terminal, and the negative electrode terminal will be described in detail.

1) Negative Electrode

The negative electrode can include a negative electrode current collector and a negative electrode active material-containing layer. The negative electrode current collector and the negative electrode active material-containing layer can be the current collector and the active material-containing layer described concerning the electrode according to the first embodiment, respectively.

2) Positive Electrode

The positive electrode may include a positive electrode current collector and a positive electrode active material-containing layer. The positive electrode active material-containing layer may be formed on one surface or both of reverse surfaces of the positive electrode current collector. The positive electrode active material-containing layer may include a positive electrode active material, and optionally an electro-conductive agent and a binder.

As the positive electrode active material, for example, an oxide or a sulfide may be used. The positive electrode may include one kind of positive electrode active material, or alternatively, include two or more kinds of positive electrode active materials. Examples of the oxide and sulfide include compounds capable of having Li (lithium) and Li ions be inserted and extracted.

Examples of such compounds include manganese dioxides (MnO₂), iron oxides, copper oxides, nickel oxides, lithium manganese composite oxides (e.g., LiₓMn₂O₄ or LiₓMnO₂; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0≤y<1), lithium manganese cobalt composite oxides (e.g., LiₓMn_{y}Co_{1-y}O₂; 0<x≤1, 0<y≤1), lithium manganese nickel composite oxides having a spinel structure (e.g., LiₓMn_{2-y}Ni_{y}O₄; 0<x≤1, 0<y<2), lithium phosphates having an olivine structure (e.g., LiₓFePO₄; 0<x≤1, LiₓFe_{1-y}Mn_{y}PO₄; 0<x≤1, 0<y<1, and LiₓCoPO₄; 0<x≤1), iron sulfates [Fe₂(SO₄)₃], vanadium oxides (e.g., V₂O₅), and lithium nickel cobalt manganese composite oxides (LiₓNi_{1-y-z}Co_{y}Mn_{z}O₂; 0<x≤1, 0<y<1, 0<z<1, y+z<1).

More preferred examples of the positive electrode active material include lithium manganese composite oxides having a spinel structure (e.g., LiₓMn₂O₄; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiNi_{1-y}Co_{y}O₂; 0<x≤1), lithium manganese nickel composite oxides having a spinel structure (e.g., LiₓMn_{2-y}Ni_{y}O₄; 0<x≤1, 0<y<2), lithium manganese cobalt composite oxides (e.g., LiₓMn_{y}Co_{1-y}O₂; 0<x≤1, 0<y<1), lithium iron phosphates (e.g., LiₓFePO₄; 0<x≤1), and lithium nickel cobalt manganese composite oxides (LiₓNi_{1-y-z}Co_{y}Mn_{z}O₂; 0<x≤1, 0<y<1, 0<z<1, y+z<1). The positive electrode potential can be made high by using these positive electrode active materials.

When an room temperature molten salt is used as the nonaqueous electrolyte of the battery, preferred examples of the positive electrode active material include lithium iron phosphate, LiₓNPO₄F (0≤x≤1), lithium manganese composite oxide, lithium nickel composite oxide, and lithium nickel cobalt composite oxide. Since these compounds have low reactivity with room temperature molten salts, cycle life can be improved. The room temperature molten salt will be described later in detail.

The primary particle size of the positive electrode active material is preferably within a range of from 100 nm to 1 μm. The positive electrode active material having a primary particle size of 100 nm or more is easy to handle during industrial production. In the positive electrode active material having a primary particle size of 1 μm or less, diffusion of lithium ions within solid can proceed smoothly.

The specific surface area of the positive electrode active material is preferably within a range of from 0.1 m²/g to 10 m²/g. The positive electrode active material having a specific surface area of 0.1 m²/g or more can secure sufficient sites for inserting and extracting Li ions. The positive electrode active material having a specific surface area of 10 m²/g or less is easy to handle during industrial production, and can secure a good charge and discharge cycle performance.

The binder is added to fill gaps among the dispersed positive electrode active material and also to bind the positive electrode active material with the positive electrode current collector. Examples of the binder include polytetrafluoroethylene (PTFE), polyvinylidene fluoride (PVdF), fluorine rubber, polyacrylate compounds, imide compounds, carbokymethyl cellulose (CMC), and salts of the CMC. One of these may be used as the binder, or two or more may be used in combination as the binder.

The conductive agent is added to improve a current collection performance and to suppress the contact resistance between the active material and the current collector. Examples of the conductive agent include vapor grown carbon fiber (VGCF), carbon black such as acetylene black, and carbonaceous substances such as graphite. One of these may be used as the conductive agent, or two or more may be used in combination as the conductive agent. The conductive agent may be omitted.

In the positive electrode active material-containing layer, the positive electrode active material and binder are preferably blended in proportions within ranges of 80% by mass to 98% by mass, and 2% by mass to 20% by mass, respectively.

When the amount of the binder is 2% by mass or more, sufficient electrode strength can be achieved. When the amount of the binder is 20% by mass or less, the amount of insulator in the electrode is reduced, and thereby the internal resistance can be decreased.

When a conductive agent is added, the positive electrode active material, binder, and conductive agent are preferably blended in proportions of 77% by mass to 95% by mass, 2% by mass to 20% by mass, and 3% by mass to 15% by mass, respectively.

When the amount of the conductive agent is 3% by mass or more, the above-described effects can be expressed. By setting the amount of the conductive agent to 15% by mass or less, the proportion of conductive agent that contacts the electrolyte can be made low. When this proportion is low, the decomposition of an electrolyte can be reduced during storage under high temperatures.

The positive electrode current collector is preferably an aluminum foil, or an aluminum alloy foil containing one or more elements selected from the group consisting of Mg, Ti, Zn, Ni, Cr, Mn, Fe, Cu, and Si.

The thickness of the aluminum foil or aluminum alloy foil is preferably within a range of from 5 μm to 20 μm, and more preferably 15 μm or less. The purity of the aluminum foil is preferably 99% by mass or more. The amount of transition metal such as iron, copper, nickel, or chromium contained in the aluminum foil or aluminum alloy foil is preferably 1% by mass or less.

The positive electrode current collector can include a portion on one side where the positive electrode active material-containing layer is not carried on any surfaces. This portion acts as a positive electrode current collector tab.

The positive electrode can be produced in accordance with, for example, the same procedure as that of the electrode according to the first embodiment.

3) Electrolyte

As the electrolyte, for example, a liquid nonaqueous electrolyte or a gel nonaqueous electrolyte may be used. The liquid nonaqueous electrolyte is prepared by dissolving an electrolyte salt in an organic solvent. The concentration of the electrolyte salt is preferably 0.5 mol/L to 2.5 mol/L.

Examples of the electrolyte salt include lithium salts such as lithium perchlorate (LiClO₄), lithium hexafluorophosphate (LiPF₆), lithium tetrafluoroborate (LiBF₄), hexafluoro arsenic lithium (LiAsF₆), lithium trifluoromethansulfonate (LiCF₃SO₃), bistrifluoromethylsulfonylimide lithium (LiTFSI; LiN(CF₃SO₂)₂), and mixtures thereof. The electrolyte salt is preferably less likely to be oxidized even at high potentials, and LiPF₆ is most preferred.

Examples of the organic solvent include cyclic carbonates such as propylene carbonate (PC), ethylene carbonate (EC), or vinylene carbonate (VC); linear carbonates such as diethyl carbonate (DEC), dimethyl carbonate (DMC), or methyl ethyl carbonate (MEC); cyclic ethers such as tetrahydrofuran (THF), 2-methyl tetrahydrofuran (2-MeTHF), or dioxolane (DOX); linear ethers such as dimethoxy ethane (DME) or diethoxy ethane (DEE); γ-butyrolactone (GBL), acetonitrile (AN), and sulfolane (SL). These organic solvents may be used singularly or as a mixed solvent.

The gel-like nonaqueous electrolyte is prepared by obtaining a composite of a liquid nonaqueous electrolyte and a polymeric material. Examples of the polymeric material include polyvinylidene fluoride (PVdF), polyacrylonitrile (PAN), polyethylene oxide (PEO), and mixtures thereof.

Alternatively, the nonaqueous electrolyte may be, for example, a room temperature molten salt (ionic melt) including lithium ions, a polymer solid electrolyte, or an inorganic solid electrolyte, other than the liquid nonaqueous electrolyte or the gel nonaqueous electrolyte.

The electrolyte may be an aqueous electrolyte. The aqueous electrolyte contains an aqueous solvent and an electrolyte salt. The aqueous electrolyte may be a liquid. A liquid aqueous electrolyte is prepared by dissolving the electrolyte salt serving as a solute in the aqueous solvent. The electrolyte salt may be the same as the electrolyte salt described above.

As the aqueous solvent, a solution containing water can be used. Here the solution containing water may be pure water or a solvent mixture of water and an organic solvent.

The room temperature molten salt (ionic melt) means compounds which may exist in a liquid state at normal temperature (15 to 25° C.) among organic salts constituted of combinations of organic cations and anions. The room temperature molten salts include those which singly exist in a liquid state, those which are put into a liquid state when mixed with an electrolyte, those which are put into a liquid state when dissolved in an organic solvent, and mixture thereof. Generally, the melting point of the room temperature molten salt used in a secondary battery is 25° C. or less. Further, the organic cation generally has a quaternary ammonium skeleton.

The polymer solid electrolyte is prepared by dissolving the electrolyte salt in a polymeric material, and solidifying it.

The inorganic solid electrolyte is a solid substance having lithium ion conductivity.

4) Separator

The separator may be made of, for example, a porous film or synthetic resin nonwoven fabric including polyethylene, polypropylene, cellulose, or polyvinylidene fluoride (PVdF). In view of safety, a porous film made of polyethylene or polypropylene is preferred. This is because such a porous film melts at a fixed temperature and thus able to shut off current.

5) Container Member

As the container member, for example, a container made of laminate film or a container made of metal may be used.

The thickness of the laminate film is, for example, 0.5 mm or less, and preferably 0.2 mm or less.

As the laminate film, used is a multilayer film including multiple resin layers and a metal layer sandwiched between the resin layers. The resin layer may include, for example, a polymeric material such as polypropylene (PP), polyethylene (PE), nylon, or polyethylene terephthalate (PET). The metal layer is preferably made of aluminum foil or an aluminum alloy foil, so as to reduce weight. The laminate film may be formed into the shape of a container member, by heat-sealing.

The wall thickness of the metal container is, for example, 1 mm or less, more preferably 0.5 mm or less, and still more preferably 0.2 mm or less.

The metal case is made, for example, of aluminum or an aluminum alloy. The aluminum alloy preferably contains elements such as magnesium, zinc, or silicon. If the aluminum alloy contains a transition metal such as iron, copper, nickel, or chromium, the content thereof is preferably 100 ppm by mass or less.

The shape of the container member is not particularly limited. The shape of the container member may be, for example, flat (thin), square, cylinder, coin, or button-shaped. The container member can be properly selected depending on battery size or intended use of the battery.

6) Negative Electrode Terminal

The negative electrode terminal may be made of a material that is electrochemically stable at the potential at which Li is inserted into and extracted from the above-described negative electrode active material, and has electrical conductivity. Specific examples of the material for the negative electrode terminal include copper, nickel, stainless steel, aluminum, and aluminum alloy containing at least one element selected from the group consisting of Mg, Ti, Zn, Mn, Fe, Cu, and Si. Aluminum or aluminum alloy is preferred as the material for the negative electrode terminal. The negative electrode terminal is preferably made of the same material as the negative electrode current collector, in order to reduce the contact resistance with the negative electrode current collector.

7) Positive Electrode Terminal

The positive electrode terminal may be made of, for example, a material that is electrically stable in the potential range of 3 V to 4.5 V (vs. Li/Li⁺) relative to the oxidation-and-reduction potential of lithium, and has electrical conductivity. Examples of the material for the positive electrode terminal include aluminum and an aluminum alloy containing one or more selected from the group consisting of Mg, Ti, Zn, Mn, Fe, Cu, and Si. The positive electrode terminal is preferably made of the same material as the positive electrode current collector, in order to reduce contact resistance with the positive electrode current collector.

Next, the secondary battery according to the second embodiment will be more specifically described with reference to the drawings.

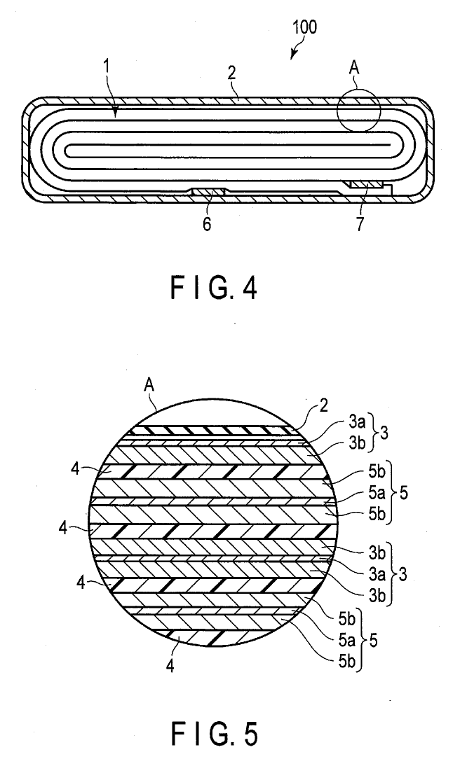

FIG. 4 is a cross-sectional view schematically showing an example of a secondary battery according to the second embodiment. FIG. 5 is an enlarged cross-sectional view of section A of the secondary battery shown in FIG. 4.

The secondary battery 100 shown in FIGS. 4 and 5 includes a bag-shaped container member 2 shown in FIG. 4, an electrode group 1 shown in FIGS. 4 and 5, and an electrolyte, which is not shown. The electrode group 1 and the electrolyte are housed in the bag-shaped container member 2. The electrolyte (not shown) is held in the electrode group 1.

The bag shaped container member 2 is made of a laminate film including two resin layers and a metal layer sandwiched between the resin layers.

As shown in FIG. 4, the electrode group 1 is a wound electrode group in a flat form. The wound electrode group 1 in a flat form includes a negative electrode 3, a separator 4, and a positive electrode 5, as shown in FIG. 5. The separator 4 is sandwiched between the negative electrode 3 and the positive electrode 5.

The negative electrode 3 includes a negative electrode current collector 3a and a negative electrode active material-containing layer 3b. The active material is included in the negative electrode active material-containing layer 3b. At the portion of the negative electrode 3 positioned outermost among the wound electrode group 1, the negative electrode active material-containing layer 3b is formed only on an inner surface of the negative electrode current collector 3a, as shown in FIG. 5. For the other portions of the negative electrode 3, negative electrode active material-containing layers 3b are formed on both of reverse surfaces of the negative electrode current collector 3a.

The positive electrode 5 includes a positive electrode current collector 5a and positive electrode active material-containing layers 5b formed on both of reverse surfaces of the positive electrode current collector 5a.

As shown in FIG. 4, a negative electrode terminal 6 and positive electrode terminal 7 are positioned in vicinity of the outer peripheral edge of the wound electrode group 1. The negative electrode terminal 6 is connected to a portion of the negative electrode current collector 3a of the negative electrode 3 positioned outermost. The positive electrode terminal 7 is connected to the positive electrode current collector 5a of the positive electrode 5 positioned outermost. The negative electrode terminal 6 and the positive electrode terminal 7 extend out from an opening of the bag-shaped container member 2. The bag-shaped container member 2 is heat-sealed by a thermoplastic resin layer arranged on the interior thereof.

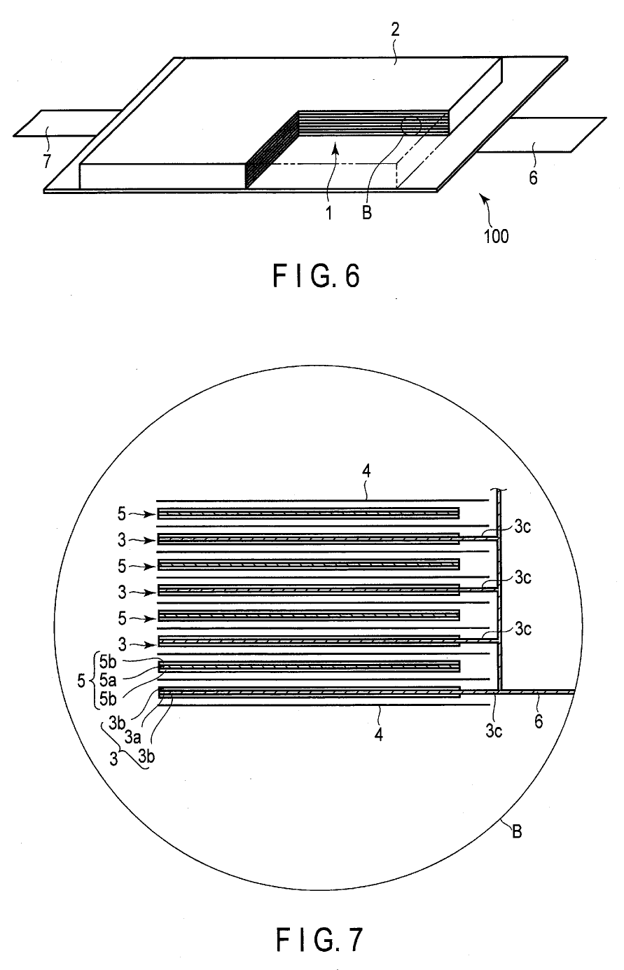

The secondary battery according to the second embodiment is not limited to the secondary battery of the structure shown in FIGS. 4 and 5, and may be, for example, a battery of a structure as shown in FIGS. 6 and 7.

FIG. 6 is a partially cut-out perspective view schematically showing another example of a secondary battery according to the second embodiment. FIG. 7 is an enlarged cross-sectional view of section B of the secondary battery shown in FIG. 6.

The secondary battery 100 shown in FIGS. 6 and 7 includes an electrode group 1 shown in FIGS. 6 and 7, a container member 2 shown in FIG. 6, and an electrolyte, which is not shown. The electrode group 1 and the electrolyte are housed in the container member 2. The electrolyte is held in the electrode group 1.

The container member 2 is made of a laminate film including two resin layers and a metal layer sandwiched between the resin layers.

As shown in FIG. 7, the electrode group 1 is a stacked electrode group. The stacked electrode group 1 has a structure in which positive electrodes 3 and negative electrodes 5 are alternately stacked with separator(s) 4 sandwiched therebetween.

The electrode group 1 includes a plurality of the negative electrodes 3. Each of the negative electrodes 3 includes the negative electrode current collector 3a and the negative electrode active material-containing layers 3b supported on both surfaces of the negative electrode current collector 3a. The electrode group 1 further includes a plurality of the positive electrodes 5. Each of the positive electrodes 5 includes the positive electrode current collector 5a and the positive electrode active material-containing layers 5b supported on both surfaces of the positive electrode current collector 5a.

The negative electrode current collector 3a of each of the negative electrodes 3 includes at its side a portion 3c where the negative electrode active material-containing layer 3b is not supported on any surface. This portion 3c serves as a negative electrode tab. As shown in FIG. 7, the portion 3c serving as the negative electrode tab does not overlap the positive electrode 5. A plurality of the negative electrode tabs (portions 3c) are electrically connected to the belt-like negative electrode terminal 6. A leading end of the belt-like negative electrode terminal 6 is drawn to the outside from a container member 2.

Although not shown, the positive electrode current collector 5a of each of the positive electrodes 5 includes at its side a portion where the positive electrode active material-containing layer 5b is not supported on any surface. This portion serves as a positive electrode tab. Like the negative electrode tab (portion 3 c), the positive electrode tab does not overlap the negative electrode 3. Further, the positive electrode tab is located on the opposite side of the electrode group 1 with respect to the negative electrode tab (portion 3c). The positive electrode tab is electrically connected to the belt-like positive electrode terminal 7. A leading end of the belt-like positive electrode terminal 7 is located on the opposite side of the negative electrode terminal 6 and drawn to the outside from the container member 2.

The secondary battery according to the second embodiment includes the electrode according to the first embodiment. For this reason, the secondary battery according to the second embodiment can implement excellent rapid charge-and-discharge performance and cycle performance.

### Third Embodiment

According to a third embodiment, a battery module is provided. The battery module according to the third embodiment includes plural secondary batteries according to the second embodiment.

In the battery module according to the third embodiment, each of the single batteries may be arranged electrically connected in series, in parallel, or in a combination of in-series connection and in-parallel connection.

An example of the battery module according to the third embodiment will be described next with reference to the drawings.

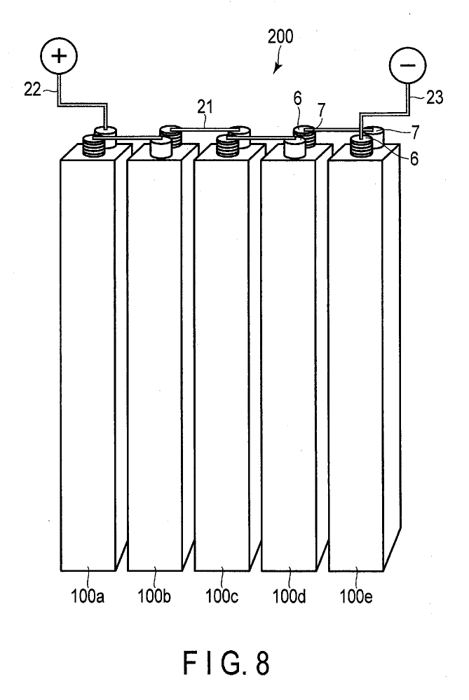

FIG. 8 is a perspective view schematically showing an example of the battery module according to the third embodiment. A battery module 200 shown in FIG. 8 includes five single-batteries 100a to 100e, four bus bars 21, a positive electrode-side lead 22, and a negative electrode-side lead 23. Each of the five single-batteries 100a to 100e is a secondary battery according to the second embodiment.

For example, a bus bar 21 connects a negative electrode terminal 6 of one single-battery 100a and a positive electrode terminal 7 of the single-battery 100b positioned adjacent. The five single-batteries 100 are thus connected in series by the four bus bars 21. That is, the battery module 200 shown in FIG. 8 is a battery module of five in-series connection.

As shown in FIG. 8, the positive electrode terminal 7 of the single-battery 100a located at one end on the left among the row of the five single-batteries 100a to 100e is connected to the positive electrode-side lead 22 for external connection. In addition, the negative electrode terminal 6 of the single-battery 100e located at the other end on the right among the row of the five single-batteries 100a to 100e is connected to the negative electrode-side lead 23 for external connection.

The battery module according to the third embodiment includes the secondary battery according to the second embodiment. Hence, the battery module according to the third embodiment can implement excellent rapid charge-and-discharge performance and cycle performance.

### Fourth Embodiment

According to a fourth embodiment, a battery pack is provided. The battery pack includes a battery module according to the third embodiment. The battery pack may include a single secondary battery according to the second embodiment, in place of the battery module according to the third embodiment.

The battery pack according to the fourth embodiment may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack according to the fourth embodiment may further comprise an external power distribution terminal. The external power distribution terminal is configured to externally output current from the secondary battery, and to input external current into the secondary battery. In other words, when the battery pack is used as a power source, the current is provided out via the external power distribution terminal. When the battery pack is charged, the charging current (including regenerative energy of motive force of vehicles such as automobiles) is provided to the battery pack via the external power distribution terminal.

Next, an example of a battery pack according to the fourth embodiment will be described with reference to the drawings.

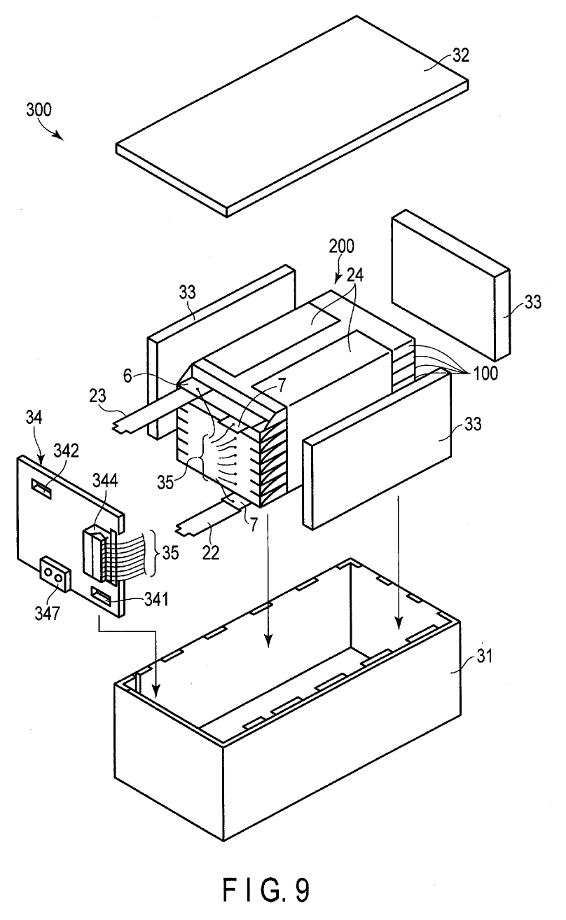

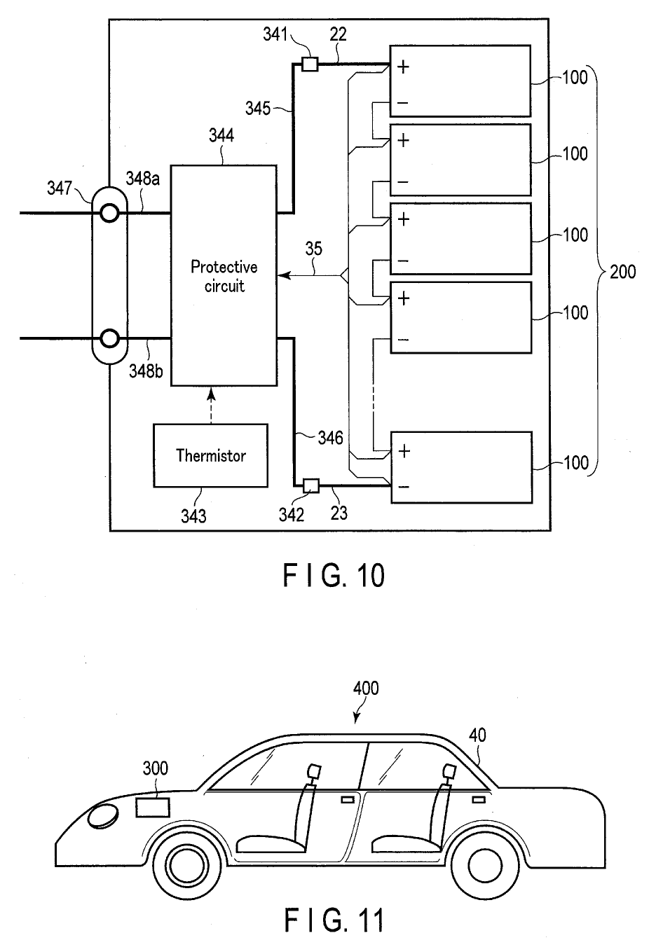

FIG. 9 is an exploded perspective view schematically showing an example of the battery pack according to the fourth embodiment. FIG. 10 is a block diagram showing an example of an electric circuit of the battery pack shown in FIG. 9.

A battery pack 300 shown in FIGS. 9 and 10 includes a housing container 31, a lid 32, protective sheets 33, a battery module 200, a printed wiring board 34, wires 35, and an insulating plate (not shown).

The housing container 31 shown in FIG. 9 is a square bottomed container having a rectangular bottom surface. The housing container 31 is configured to be capable of storing the protective sheets 33, the battery module 200, the printed wiring board 34, and the wires 35. The lid 32 has a rectangular shape. The lid 32 covers the housing container 31 to store the battery module 200 and so on. The housing container 31 and the lid 32 are provided with openings, connection terminals, or the like (not shown) for connection to an external device or the like.

The battery module 200 includes plural single-batteries 100, a positive electrode-side lead 22, a negative electrode-side lead 23, and an adhesive tape 24.

A single-battery 100 has a structure shown in FIGS. 6 and 7. At least one of the plural single-batteries 100 is a secondary battery according to the second embodiment. The plural single-batteries 100 are stacked such that the negative electrode terminals 6 and the positive electrode terminals 7, which extend outside, are directed toward the same direction. The plural single-batteries 100 are electrically connected in series, as shown in FIG. 10. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape 24 fastens the plural single-batteries 100. The plural single-batteries 100 may be fixed using a heat-shrinkable tape in place of the adhesive tape 24. In this case, the protective sheets 33 are arranged on both side surfaces of the battery module 200, and the heat-shrinkable tape is wound around the battery module 200 and protective sheets 33. After that, the heat-shrinkable tape is shrunk by heating to bundle the plural single-batteries 100.

One end of the positive electrode-side lead 22 is connected to the positive electrode terminal 7 of the single-battery 100 located lowermost in the stack of the single-batteries 100. One end of the negative electrode-side lead 23 is connected to the negative electrode terminal 6 of the single-battery 100 located uppermost in the stack of the single-batteries 100.

A printed wiring board 34 is disposed on the one inner surface along the short-side direction of inner surfaces of the housing container 31. The printed wiring board 34 includes a positive electrode-side connector 341, a negative electrode-side connector 342, a thermistor 343, a protective circuit 344, wirings 345 and 346, an external power distribution terminal 347, a plus-side (positive-side) wire 348a, and a minus-side (negative-side) wire 348b. One main surface of the printed wiring board 34 faces the surface of the battery module 200 from which the negative electrode terminals 6 and the positive electrode terminals 7 extend out. An insulating plate (not shown) is disposed in between the printed wiring board 34 and the battery module 200.

The positive electrode-side connector 341 is provided with a through-hole. By inserting the other end of the positive electrode-side lead 22 into the though-hole, the positive electrode-side connector 341 and the positive electrode-side lead 22 become electrically connected. The negative electrode-side connector 342 is provided with a through-hole. By inserting the other end of the negative electrode-side lead 23 into the though-hole, the negative electrode-side connector 342 and the negative electrode-side lead 23 become electrically connected.

The thermistor 343 is fixed to one main surface of the printed wiring board 34. The thermistor 343 detects the temperature of each single-battery 100 and transmits detection signals to the protective circuit 344.

The external power distribution terminal 347 is fixed to the other main surface of the printed wiring board 34. The external power distribution terminal 347 is electrically connected to device(s) that exists outside the battery pack 300.

The protective circuit 344 is fixed to the other main surface of the printed wiring board 34. The protective circuit 344 is connected to the external power distribution terminal 347 via the plus-side wire 348a. The protective circuit 344 is connected to the external power distribution terminal 347 via the minus-side wire 348b. In addition, the protective circuit 344 is electrically connected to the positive electrode-side connector 341 via the wiring 345. The protective circuit 344 is electrically connected to the negative electrode-side connector 342 via the wiring 346. Furthermore, the protective circuit 344 is electrically connected to each of the plural single-batteries 100 via the wires 35.

The protective sheets 33 are arranged on both inner surfaces of the housing container 31 along the long-side direction and on the inner surface along the short-side direction, facing the printed wiring board 34 across the battery module 200 positioned therebetween. The protective sheets 33 are made of, for example, resin or rubber.

The protective circuit 344 controls charge and discharge of the plural single-batteries 100. The protective circuit 344 is also configured to cut-off electric connection between the protective circuit 344 and the external power distribution terminal 347 to external devices, based on detection signals transmitted from the thermistor 343 or detection signals transmitted from each single-battery 100 or the battery module 200.

An example of the detection signal transmitted from the thermistor 343 is a signal indicating that the temperature of the single-battery (single-batteries) 100 is detected to be a predetermined temperature or more. An example of the detection signal transmitted from each single-battery 100 or the battery module 200 is a signal indicating detection of over-charge, over-discharge, and overcurrent of the single-battery (single-batteries) 100.

When detecting over-charge or the like for each of the single batteries 100, the battery voltage may be detected, or a positive electrode potential or negative electrode potential may be detected. In the latter case, a lithium electrode to be used as a reference electrode may be inserted into each single battery 100.

Note that, as the protective circuit 344, a circuit included in a device (for example, an electronic device or an automobile) that uses the battery pack 300 as a power source may be used.

As described above, the battery pack 300 includes the external power distribution terminal 347. Hence, the battery pack 300 can output current from the battery module 200 to an external device and input current from an external device to the battery module 200 via the external power distribution terminal 347. In other words, when using the battery pack 300 as a power source, the current from the battery module 200 is supplied to an external device via the external power distribution terminal 347. When charging the battery pack 300, a charge current from an external device is supplied to the battery pack 300 via the external power distribution terminal 347. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may be omitted. In this case, the positive electrode-side lead 22 and the negative electrode-side lead 23 may be used as the external power distribution terminal.

Such a battery pack 300 is used, for example, in applications where excellent cycle performance is demanded when a large current is extracted. More specifically, the battery pack 300 is used as, for example, a power source for electronic devices, a stationary battery, or an onboard battery for vehicles. An example of the electronic device is a digital camera. The battery pack 300 is particularly favorably used as an onboard battery.

The battery pack according to the fourth embodiment includes the secondary battery according to the second embodiment or the battery module according to the third embodiment. Hence, the battery pack according to the fourth embodiment can implement excellent rapid charge-and-discharge performance and cycle performance.

### Fifth Embodiment

According to a fifth embodiment, a vehicle is provided. The battery pack according to the fourth embodiment is installed on this vehicle.

In the vehicle according to the fifth embodiment, the battery pack is configured, for example, to recover regenerative energy from motive force of the vehicle. The vehicle according to the fifth embodiment can include a mechanism configured to convert kinetic energy of the vehicle into regenerative energy.

Examples of the vehicle according to the fifth embodiment include two- to four-wheeled hybrid electric automobiles, two- to four-wheeled electric automobiles, electric assist bicycles, and railway cars.

In the vehicle according to the fifth embodiment, the installing position of the battery pack is not particularly limited. For example, the battery pack may be installed in the engine compartment of the vehicle, in rear parts of the vehicle, or under seats.

An example of the vehicle according to the fifth embodiment is explained below, with reference to the drawings.

FIG. 11 is a cross-sectional view schematically showing an example of a vehicle according to the fifth embodiment.

A vehicle 400, shown in FIG. 11 includes a vehicle body 40 and a battery pack 300 according to the fourth embodiment. In FIG. 11, the vehicle 400 is a four-wheeled automobile.

This vehicle 400 may have plural battery packs 300 installed. In such a case, the battery packs 300 may be connected in series, connected in parallel, or connected in a combination of in-series connection and in-parallel connection.

An example is shown in FIG. 11, where the battery pack 300 is installed in an engine compartment located at the front of the vehicle body 40. As described above, the battery pack 300 may be installed, for example, in rear sections of the vehicle body 40, or under a seat. The battery pack 300 may be used as a power source of the vehicle 400. The battery pack 300 can also recover regenerative energy of power of the vehicle 400.

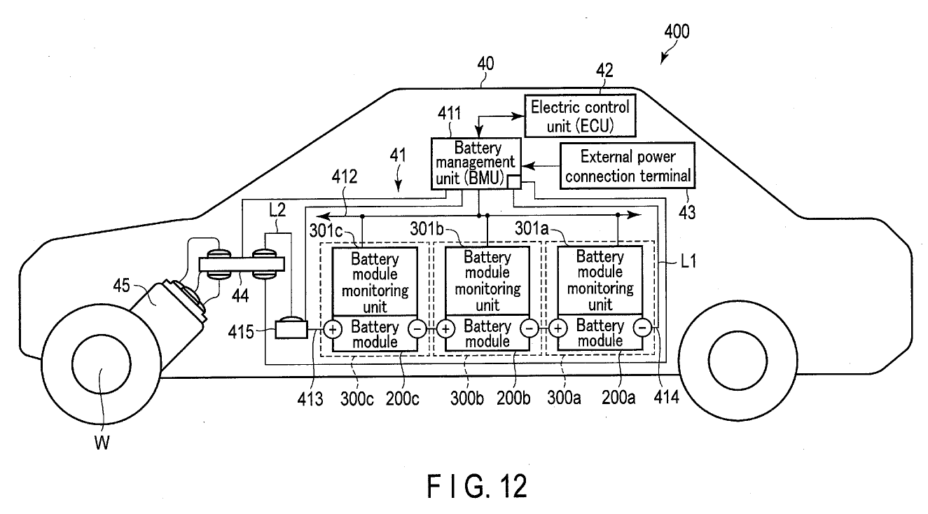

Next, with reference to FIG. 12, an aspect of operation of the vehicle according to the fifth embodiment is explained.

FIG. 12 is a view schematically showing another example of the vehicle according to the fifth embodiment. A vehicle 400, shown in FIG. 12, is an electric automobile.

The vehicle 400, shown in FIG. 12, includes a vehicle body 40, a vehicle power source 41, a vehicle ECU (electric control unit) 42, which is a master controller of the vehicle power source 41, an external terminal (an external power connection terminal) 43, an inverter 44, and a drive motor 45.

The vehicle 400 includes the vehicle power source 41, for example, in the engine compartment, in the rear sections of the automobile body, or under a seat. In FIG. 12, the position of the vehicle power source 41 installed in the vehicle 400 is schematically shown.

The vehicle power source 41 includes plural (for example, three) battery packs 300a, 300b and 300c, a battery management unit (EMU) 411, and a communication bus 412.

The three battery packs 300a, 300b and 300c are electrically connected in series. The battery pack 300a includes a battery module 200a and a battery module monitoring unit (for example, VTM: voltage temperature monitoring) 301a. The battery pack 300b includes a battery module 200b, and a battery module monitoring unit 301b. The battery pack 300c includes a battery module 200c, and a battery module monitoring unit 301c. The battery packs 300a, 300b and 300c can each be independently removed, and may be exchanged by a different battery pack 300.

Each of the battery modules 200a to 200c includes plural single-batteries connected in series. At least one of the plural single-batteries is the secondary battery according to the second embodiment. The battery modules 200a to 200c each perform charging and discharging via a positive electrode terminal 413 and a negative electrode terminal 414.

In order to collect information concerning security of the vehicle power source 41, the battery management unit 411 performs communication with the battery module monitoring units 301a to 301c and collects information such as voltages or temperatures of the single-batteries 100 included in the battery modules 200a to 200c included in the vehicle power source 41.

The communication bus 412 is connected between the battery management unit 411 and the battery module monitoring units 301a to 301c. The communication bus 412 is configured so that multiple nodes (i.e., the battery management unit and one or more battery module monitoring units) share a set of communication lines. The communication bus 412 is, for example, a communication bus configured based on CAN (Control Area Network) standard.

The battery module monitoring units 301a to 301c measure a voltage and a temperature of each single-battery in the battery modules 200a to 200c based on commands from the battery management unit 411. It is possible, however, to measure the temperatures only at several points per battery module, and the temperatures of all of the single-batteries need not be measured.

The vehicle power source 41 may also have an electromagnetic contactor (for example, a switch unit 415 shown in FIG. 12) for switching connection between the positive electrode terminal 413 and the negative electrode terminal 414. The switch unit 415 includes a precharge switch (not shown), which is turned on when the battery modules 200a to 200c are charged, and a main switch (not shown), which is turned on when battery output is supplied to a load. The precharge switch and the main switch include a relay circuit (not shown), which is turned on or off based on a signal provided to a coil disposed near a switch element.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 controls an output voltage based on control signals from the battery management unit 411 or the vehicle ECU 42, which controls the entire operation of the vehicle.

The drive motor 45 is rotated by electric power supplied from the inverter 44. The rotation is transferred to an axle and driving wheels W via a differential gear unit, for example.

The vehicle 400 also includes a regenerative brake mechanism, though not shown. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The direct current is inputted into the vehicle power source 41.

One terminal of a connecting line L1 is connected via a current detector (not shown) in the battery management unit 411 to the negative electrode terminal 414 of the vehicle power source 41. The other terminal of the connecting line L1 is connected to a negative electrode input terminal of the inverter 44.

One terminal of a connecting line L2 is connected via the switch unit 415 to the positive electrode terminal 413 of the vehicle power source 41. The other terminal of the connecting line L2 is connected to a positive electrode input terminal of the inverter 44.

The external terminal 43 is connected to the battery management unit 411. The external terminal 43 is able to connect, for example, to an external power source.

The vehicle ECU 42 cooperatively controls the battery management unit 411 together with other units in response to inputs operated by a driver or the like, thereby performing the management of the whole vehicle. Data concerning the security of the vehicle power source 41, such as a remaining capacity of the vehicle power source 41, are transferred between the battery management unit 411 and the vehicle ECU 42 via communication lines.

The vehicle according to the fifth embodiment includes the battery pack according to the fourth embodiment. Hence, the vehicle according to the fifth embodiment can implement excellent rapid charge-and-discharge performance and a long life.

### EXAMPLES

Examples of the present invention will be described below. However, the present invention is not limited to the examples to be described below.

### Example 1

(Preparation of Active Material Particles AM1)

A monoclinic niobium-titanium composite oxide was prepared by a solid phase method. More specifically, powder of titanium dioxide (TiO₂) and powder of niobium pentoxide (Nb₂O₅) were mixed to obtain a powder mixture. Note that the molar ratio of the niobium and titanium in the powder mixture was 1:1.

Next, the powder mixture and ethanol were mixed to obtain a solution mixture. Next, for the solution mixture, pulverization was performed using a wet ball mill. Then, the solution mixture after pulverization was filtered, and the filtered powder was dried to obtain a primary pulverized sample. Next, the primary pulverized sample was put into an alumina crucible and subjected to temporary firing at a temperature of 1,000° C. for 12 hrs.

Next, the primary pulverized sample after temporary firing and ethanol were mixed to obtain a solution mixture. Next, for the solution mixture, pulverization was performed using a wet ball mill. Then, the solution mixture after pulverization was filtered, and the filtered powder was dried to obtain a secondary pulverized sample. Next, the secondary pulverized sample was put into an alumina crucible and subjected to final firing at a temperature of 1,100° C. for 12 hrs.

The secondary pulverized sample after the final firing was further pulverized, thereby obtaining the powder of the active material. The powder of the active material will be referred to as the active material particles AM1 hereinafter. When the average particle size of the primary particles of the active material particles AM1 was measured using a laser diffraction distribution measuring apparatus, the average particle size was 0.6 μm.

(Preparation of Active Material Composite Material Particles C-AM1)

Next, the active material particles AM1 obtained by the above-described method were caused to carry carbon particles to obtain active material composite material particles C-AM1. More specifically, first, carbon particles, a dispersant, and pure water were mixed to prepare a dispersion. As the carbon particles, carbon black CB1 manufactured by an acetylene method was used. The average particle size of the primary particles of the carbon black CB1 measured by a laser diffraction distribution measuring apparatus was 0.05 μm. As the dispersant, polyvinyl alcohol (PVA) having a molecular weight of 350 and a degree of saponification of 98% was used. The concentration of the carbon particles in the dispersion was 2 mass %, and the concentration of the dispersant was 1 mass %.

Next, the active material particles AM1 were added to the dispersion, and water was gradually added while stirring the solution mixture, thereby preparing a processing liquid. The amounts of the carbon particles and the dispersant to 100 parts by mass of the active material were 2 parts by mass and 1 parts by mass, respectively. In addition, the solid component concentration in the processing liquid was 15 mass %.

Next, the solution mixture was subjected to spray dry, thereby obtaining the powder of the active material composite material. The powder of the active material composite material will be referred to as active material composite material particles C-AM1 hereinafter.

(Production of Negative Electrode)

The active material composite material particles C-AM1 obtained by the above-described method, graphite, carboxymethyl cellulose (CMC), styrene-butadiene rubber (SBR), and pure water were mixed to obtain a slurry. The mass ratio of the active material composite material particles C-AM1, graphite, CMC, and SBR in the slurry was 100:10:5:5.

Next, the slurry was applied to both surfaces of an aluminum foil. Note that the thickness of the aluminum foil was 12 μm. Next, the applied slurry was dried to form a negative electrode active material-containing layer on the negative electrode current collector. After that, the negative electrode active material-containing layer was pressed, thereby obtaining a negative electrode.

(Production of Positive Electrode)

First, an LiNi_{0.5}Co_{0.2}Mn_{0.3}O₂ powder, acetylene black, carbon nanofiber, polyvinylidene fluoride (PVdF), and N-methylpyrrolidone (NMP) were mixed to obtain a slurry. The mass ratio of the LiNi_{0.5}Co_{0.2}Mn_{0.3}O₂ powder, acetylene black, carbon nanofiber, and PVdF in the slurry was 100:10:10:10.

Next, the slurry was applied to both surfaces of an aluminum foil. Note that the thickness of the aluminum foil was 12 μm. Next, the applied slurry was dried to form a positive electrode active material-containing layer on the positive electrode current collector. After that, the positive electrode active material-containing layer was pressed, thereby obtaining a positive electrode.

(Production of Electrode Group)

First, the negative electrodes and the positive electrodes obtained by the above-described method, and a strip-shaped separator were prepared. As the separator, a cellulose separator was used. Next, the separator was zigzag-folded. Then, a negative electrode was laminated on the uppermost layer of the zigzag-folded separator. Next, the negative electrodes and the positive electrodes were alternately inserted into the spaces formed between the separators facing each other, thereby obtaining a laminated body formed from the separators, the negative electrodes, and the positive electrodes. Note that when laminating, the positive electrode tabs of the positive electrode current collectors and the negative electrode tabs of the negative electrode current collectors were arranged such that they projected from a side surface of the laminated body and did not overlap in the laminating direction. Next, the negative electrode tabs projecting from the side surface of the laminated body were welded to connect the negative electrode terminals. Next, the positive electrode tabs projecting from the side surface of the laminated body were welded to connect the positive electrode terminals. An electrode group was obtained in this way.

(Preparation of Nonaqueous Electrolyte)

Ethylene carbonate (EC) and diethyl carbonate (DEC) were mixed to obtain a solvent mixture. The volume ratio of EC and DEC in the solvent mixture was 1:2. Next, lithium hexafluorophosphate (LiPF₆) was dissolved in the solvent mixture to prepare a nonaqueous electrolyte. The molar concentration of LiPF₆ in the nonaqueous electrolyte was 1 mol/m³.

(Production of Nonaqueous Electrolyte Secondary Battery)

Next, the electrode group obtained by the above-described method was stored in a container member made of a laminated film. At this time, the negative electrode terminals and the positive electrode terminals were extended to the outside of the container member. Next, the periphery of the laminated film was bonded by fusion except a part thereof. Then, the nonaqueous electrolyte was poured from the unsealed portion of the laminated film, that is, a liquid injection port. Next, the liquid injection port was bonded by fusion, thereby obtaining a nonaqueous electrolyte secondary battery. The discharge capacity of the battery was 3.0 Ah.

### Example 2

Active material composite material particles were obtained by the same method as that described in Example 1 except that the amount of carbon particles to 100 parts by mass of the active material was changed from 2 parts by mass to 5 parts by mass, and the amount of the dispersant was changed from 1 parts by mass to 2 parts by mass. A secondary battery was obtained by the same method as that described in Example 1 except that the active material composite material particles were used.

### Example 3

Active material composite material particles were obtained by the same method as that described in Example 1 except that the amount of carbon particles to 100 parts by mass of the active material was changed from 2 parts by mass to 3 parts by mass, and the amount of the dispersant was changed from 1 parts by mass to 1.5 parts by mass. A secondary battery was obtained by the same method as that described in Example 1 except that the active material composite material particles were used.

### Example 4

An active material was obtained by the same method as that described in Example 1 except that the temperature in final firing was changed from 1,100° C. to 1,200° C. The active material will be referred to as active material particles AM2 hereinafter. When the average particle size of the primary particles of the active material particles AM2 was measured using a laser diffraction distribution measuring apparatus, the average particle size was 3 μm.

An active material composite material was obtained by the same method as that described in Example 1 except that the active material particles AM2 were used in place of the active material particles AM1, and carbon black CB2 was used in place of the carbon black CB1 as carbon particles. Note that the carbon black CB2 was carbon black manufactured by an acetylene method, and the average particle size of the primary particles measured by a laser diffraction distribution measuring apparatus was 0.04 μm.

A secondary battery was obtained by the same method as that described in Example 1 except that the active material composite material particles were used.

### Example 5

Active material composite material particles were obtained by the same method as that described in Example 4 except that the amount of carbon particles to 100 parts by mass of the active material was changed from 2 parts by mass to 5 parts by mass, and the amount of the dispersant was changed from 1 parts by mass to 1.5 parts by mass. A secondary battery was obtained by the same method as that described in Example 1 except that the active material composite material particles were used.

### Example 6

Active material composite material particles were obtained by the same method as that described in Example 4 except that the amount of carbon particles to 100 parts by mass of the active material was changed from 2 parts by mass to 3 parts by mass, and the amount of the dispersant was changed from 1 parts by mass to 1.5 parts by mass. A secondary battery was obtained by the same method as that described in Example 1 except that the active material composite material particles were used.

### Example 7

Active material composite material particles were obtained by the same method as that described in Example 1 except that sodium alginate was used in place of PVA as the dispersant. A secondary battery was obtained by the same method as that described in Example 1 except that the active material composite material particles were used.

### Example 8

Active material composite material particles were obtained by the same method as that described in Example 1 except that potassium alginate was used in place of PVA as the dispersant. A secondary battery was obtained by the same method as that described in Example 1 except that the active material composite material particles were used.

### Example 9

Active material composite material particles were obtained by the same method as that described in Example 1 except that ammonium alginate was used in place of PVA as the dispersant. A secondary battery was obtained by the same method as that described in Example 1 except that the active material composite material particles were used.

### Comparative Example 1

Active material composite material particles were obtained by the same method as that described in Example 1 except that PVA having a molecular weight of 1,700 was used as the dispersant. A secondary battery was obtained by the same method as that described in Example 1 except that the active material composite material particles were used.

### Comparative Example 2

An active material composite material was obtained by the same method as that described in Example 1 except that carbon black CB3 was used in place of the carbon black CB1 as carbon particles, the amount of carbon particles to 100 parts by mass of the active material was changed from 2 parts by mass to 3 parts by mass, and the amount of the dispersant was changed from 1 parts by mass to 1.5 parts by mass. Note that the carbon black CB3 was carbon black manufactured by an oil furnace method, and the average particle size of the primary particles measured by a laser diffraction distribution measuring apparatus was 0.10 μm.

A secondary battery was obtained by the same method as that described in Example 1 except that the active material composite material particles were used.

### Comparative Example 3

An active material composite material was obtained by the same method as that described in Example 1 except that the active material particles AM2 were used in place of the active material particles AM1, carbon black CB4 was used in place of the carbon black CB1 as carbon particles, the amount of carbon particles to 100 parts by mass of the active material was changed from 2 parts by mass to 5 parts by mass, and the amount of the dispersant was changed from 1 parts by mass to 2.0 parts by mass. Note that the carbon black CB4 was carbon black manufactured by a channel method, and the average particle size of the primary particles measured by a laser diffraction distribution measuring apparatus was 0.01 μm.

A secondary battery was obtained by the same method as that described in Example 1 except that the active material composite material particles were used.

### Comparative Example 4

Active material composite material particles were obtained by the same method as that described in Example 1 except that carbon black CB3 was used in place of the carbon black CB1 as carbon particles, and PVA having a molecular weight of 1,700 was used as the dispersant. A secondary battery was obtained by the same method as that described in Example 1 except that the active material composite material particles were used.

### Comparative Example 5

An active material composite material was obtained by the same method as that described in Example 1 except that the active material particles AM2 were used in place of the active material particles AM1, carbon black CB4 was used in place of the carbon black CB1 as carbon particles, and PVA having a molecular weight of 1,700 was used as the dispersant. A secondary battery was obtained by the same method as that described in Example 1 except that the active material composite material particles were used.

<Evaluation Method>

(X-Ray Diffraction Measurement)

X-ray diffraction measurement was performed for the active material particles AM1 and AM2 by the above-described method. The intensities and the values of 20 concerning all peaks shown in obtained XRD patterns sufficiently matched the intensities and the values of 20 concerning peaks described in PDF No. 01-077-1374. Hence, it was confirmed that the active material particles AM1 and AM2 were monoclinic niobium-titanium composite oxides having a single-phase structure belonging to an Nb₂TiO₇ phase.

(XPS Analysis)

For the active material composite material particles, element concentrations based on the peak of trivalent or bivalent titanium ions were calculated by the above-described method. Table 1 shows the result.

<TEM Observation>

For each the negative electrodes obtained in the examples and the comparative examples, TEM observation was performed by the above-described method, and the average particle size L1 of the primary particles of the active material and the average particle size L2 of the primary particles of the carbon particles were calculated. In addition, the ratio L2/L1 of the average particle size L2 of the primary particles of the carbon particles to the average particle size L1 of the primary particles of the active material was calculated. Table 1 shows the result.

(Raman Spectroscopic Analysis)

For each the negative electrodes obtained in the examples and the comparative examples, Raman spectroscopic analysis was performed by the above-described method, and the ratio of the mapping area S2 of the carbon particles to the area S1 of a portion where the active material was mapped was calculated. Table 1 shows the result.

(Cycle Characteristic)

For each of the secondary batteries according to the examples and the comparative examples, a cycle test was conducted. More specifically, the battery was placed in a thermostat at 45° C. Next, the battery was charged at a rate of 1 C until the battery voltage reached 3.0 V. After the battery voltage reached 3.0 V, the voltage was maintained until the current value became 0.05 C. Next, the battery was discharged at a rate of 5 C until the battery voltage reached 1.5 V. The constant current charge, constant voltage charge, and constant current discharge were repeated as one cycle. Note that an interval of 10 min was provided between the cycles. This cycle was repeated until the discharge capacity retention ratio of the battery to the discharge capacity of the battery after one cycle became 80%. Table 1 shows the result.

Data according to the examples and the comparative examples are summarized in Table 1.

TABLE 1

| | Active | Carbon particles | | Dispersant | | | | | | | Raman | Battery |
|---|---|---|---|---|---|---|---|---|---|---|---|---|
| | material | | Additive | | | Additive | XPS | | | | analysis | characteristics |
| | Firing | | amount | | | amount | analysis | TEM observation | | | covering | Cycle |
| | temperature | | (parts by | | Molecular | (parts by | Ti³⁺, Ti²⁺ | L1 | L2 | | ratio | performance |
| | (° C.) | Type | mass) | Type | weight | mass) | (atm %) | (μm) | (μm) | L2/L1 | (%) | (times) |
| Example 1 | 1100 | CB1 | 2 | PVA | 350 | 1.0 | 0 | 0.6 | 0.05 | 0.083 | 80 | 3000 |
| Example 2 | 1100 | CB1 | 5 | PVA | 350 | 2.0 | 0 | 0.6 | 0.05 | 0.083 | 98 | 4000 |
| Example 3 | 1100 | CB1 | 3 | PVA | 350 | 1.5 | 0 | 0.6 | 0.05 | 0.083 | 90 | 3500 |
| Example 4 | 1200 | CB2 | 2 | PVA | 350 | 1.0 | 0.1 | 3 | 0.04 | 0.013 | 80 | 2800 |
| Example 5 | 1200 | CB2 | 5 | PVA | 350 | 1.5 | 0.1 | 3 | 0.04 | 0.013 | 98 | 3500 |
| Example 6 | 1200 | CB2 | 3 | PVA | 350 | 1.5 | 0.1 | 3 | 0.04 | 0.013 | 90 | 3300 |
| Example 7 | 1100 | CB1 | 2 | Sodium | — | 1.0 | 0 | 0.6 | 0.05 | 0.083 | 90 | 3500 |
| | | | | alginate | | | | | | | | |
| Example 8 | 1100 | CB1 | 2 | Potassium | — | 1.0 | 0 | 0.6 | 0.05 | 0.083 | 90 | 3500 |
| | | | | alginate | | | | | | | | |
| Example 9 | 1100 | CB1 | 2 | Ammonium | — | 1.0 | 0 | 0.6 | 0.05 | 0.083 | 90 | 3500 |
| | | | | alginate | | | | | | | | |
| Comparative | 1100 | CB1 | 2 | PVA | 1700 | 1.0 | 0 | 0.6 | 0.05 | 0.083 | 70 | 2000 |
| example 1 | | | | | | | | | | | | |
| Comparative | 1100 | CB3 | 3 | PVA | 350 | 1.5 | 0 | 0.6 | 0.10 | 0.167 | 80 | 2000 |
| example 2 | | | | | | | | | | | | |
| Comparative | 1200 | CB4 | 5 | PVA | 350 | 2.0 | 0.1 | 3 | 0.01 | 0.003 | 80 | 2000 |
| example 3 | | | | | | | | | | | | |
| Comparative | 1100 | CB3 | 2 | PVA | 1700 | 1.0 | 0 | 0.6 | 0.10 | 0.167 | 70 | 1500 |
| example 4 | | | | | | | | | | | | |
| Comparative | 1200 | CB4 | 2 | PVA | 1700 | 1.0 | 0.1 | 3.0 | 0.01 | 0.003 | 70 | 1200 |
| example 5 | | | | | | | | | | | | |

In Table 1, a column with a notation “firing temperature (° C.)” under the heading “active material” describes the temperature at the time of final firing in the active material manufacturing method.

In addition, a column with a notation “type” in columns under the heading “carbon particles” describes the type of carbon black contained in each active material composite material. A column with a notation “additive amount (parts by mass)” describes the amount of carbon black to 100 parts by mass of the active material.

In addition, a column with a notation “type” in columns under the heading “dispersant” describes the type of the dispersant contained in each active material composite material. A column with a notation “molecular weight” describes the molecular weight of PVA contained in the active material composite material. In addition, a column with a notation “additive amount (parts by mass)” describes the amount of the dispersant to 100 parts by mass of the active material.

In addition, a column with a notation “Ti³⁺, Ti²⁺ (atm %)” under the heading “XPS analysis” describes the element concentration based on the peak of the trivalent or bivalent titanium ions obtained by the above-described method.

In addition, a column with a notation “L1 (μm)” in columns under the heading “TEM observation” describes the average particle size L1 of the primary particles of the active material obtained by the above-described method. Additionally, a column with a notation “L2 (μm)” describes the average particle size L2 of the primary particles of the carbon particles obtained by the above-described method. In addition, a column with a notation “L2/L1” describes the ratio L2/L1 of the average particle size L2 of the primary particles of the carbon particles to the average particle size L1 of the primary particles of the active material.

Furthermore, a column with a notation “covering ratio (%)” under the heading “Raman analysis” describes the ratio of the mapping area of the carbon particles to the area of the portion where the active material is mapped.

In addition, a column with a notation “cycle performance (times)” under the heading “battery characteristic” describes the number of cycles when the discharge capacity retention ratio became 80%.

As shown in Table 1, the cycle performance of the secondary batteries according to Examples 1 to 9 was more excellent than the cycle performance of the secondary batteries according to Comparative Examples 1 to 5. Here, in the electrodes according to Examples 1 to 9, the ratio L2/L1 of the average particle size L2 of the primary particles of the carbon particles to the average particle size L1 of the primary particles of the active material is 0.01 to 0.1, and the coverage is 80% or more. On the other hand, in the electrode according to Comparative Example 1, the ratio L2/L1 is 0.01 to 0.1, but the coverage is lower than 80%. Additionally, in the electrode according to Comparative Example 2, the coverage is 80% or more, but the ratio L2/L1 is higher than 0.1. Furthermore, in the electrode according to Comparative Example 3, the coverage is 80% or more, but the ratio L2/L1 is lower than 0.01. In addition, in the electrode according to Comparative Example 4, the ratio L2/L1 is higher than 0.1, and the coverage is lower than 80%. In addition, in the electrode according to Comparative Example 5, the ratio L2/L1 is lower than 0.1, and the coverage is lower than 80%.

According to at least one embodiment described above, an electrode is provided. The electrode includes an active material-containing layer. The active material-containing layer includes an active material composite material. The active material composite material includes an active material and carbon particles. The active material includes primary particles. The carbon particles include primary particles. An average particle size L1 of the primary particles of the active material and an average particle size L2 of primary particles of the carbon particles satisfy the following formula (1).

L1/100≤L2≤L1/10 (1)

A covering ratio of the active material by the carbon particles is not less than 80%. The covering ratio is a ratio of a mapping area of the carbon particles to a mapping area of the active material on a mapping image of a section of the active material-containing layer by Raman spectroscopy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode comprising an active material-containing layer containing an active material composite material, and the active material composite material comprising:
an active material including primary particles; and
carbon particles including primary particles,
wherein an average particle size L1 of the primary particles of the active material and an average particle size L2 of primary particles of the carbon particles satisfy the following formula (1),
L1/100≤L2≤L1/10 (1)
a covering ratio of the active material by the carbon particles is not less than 80%, and
the covering ratio is a ratio of a mapping area of the carbon particles to a mapping area of the active material on a mapping image of a section of the active material-containing layer by Raman spectroscopy.

2. The electrode according to claim 1, wherein the average particle size L2 of the primary particles of the carbon particles ranges from 0.01 μm to 0.1 μm.

3. The electrode according to claim 1, wherein the primary particles of the active material comprises a monoclinic niobium-titanium composite oxide.

4. The electrode according to claim 3, wherein the monoclinic niobium-titanium composite oxide is represented by a general formula LiₐTi₁₋ₓM1ₓNb_{2-y}M2_{y}O₇,
where in the general formula, 0≤a<5, 0≤x<1, and 0≤y<1, each of elements M1 and M2 is at least one type selected from the group consisting of V, Ta, Fe, Bi, Sb, As, P, Cr, Mo, W, B, Na, Mg, Al, and Si, and the element M1 and the element M2 may be the same or may be elements different from each other.

5. The electrode according to claim 3, wherein a concentration of at least one of trivalent titanium ions and bivalent titanium ions on the section of the active material-containing layer by X-ray photoelectron spectroscopy is not more than 1 atm %.

6. The electrode according to claim 1, wherein the active material composite material further comprises at least one compound selected from the group consisting of polyvinyl alcohol, sodium alginate, potassium alginate, and ammonium alginate.

7. A secondary battery comprising:
the electrode according to claim 1 as a negative electrode;
a positive electrode; and
an electrolyte.

8. A battery pack comprising the secondary battery according to claim 7.

9. The battery pack according to claim 8, further comprising:
an external power distribution terminal; and
a protective circuit.

10. The battery pack according to claim 8, which includes plural of the secondary battery, wherein the plural of the secondary battery are electrically connected in series, in parallel, or in combination of series and parallel.

11. A vehicle comprising the battery pack according to claim 8.

12. The vehicle according to claim 11, which comprises a mechanism configured to convert kinetic energy of the vehicle into regenerative energy.
